(19) United States
(12) Patent Application Publication
(10) Pub. No.: US 2015/0317337 A1
(43) Pub. Date: Nov. 5, 2015

(54) Systems and Methods for Identifying and Driving Actionable Insights from Data

(71) Applicant: GENERAL ELECTRIC COMPANY, Schenectady, NY (US)

(72) Inventor: Marc Thomas Edgar, Clifton Park, NY (US)

(21) Appl. No.: 14/704,939

(22) Filed: May 5, 2015

Related U.S. Application Data
(60) Provisional application No. 61/988,736, filed on May 5, 2014.

(51) Int. Cl. G06F 17/30; G06N 5/02

(52) U.S. Cl. CPC G06F 17/30306; G06N 5/02

(57) ABSTRACT

Certain examples provide systems and methods to identify and drive actionable insight from data. An example system includes a configured processor that is configured to: identify, using the processor, a pattern in a data set using an analytic algorithm, the data set associated with a domain; process, using the processor, the identified pattern to assign a score to the identified pattern based on a comparison to statistical model meta data; construct, using the processor, a semantic model modeling people, processes, and systems associated with the domain; combine, using the processor, the identified pattern with the semantic model; determine, using the semantic model and the processor, an output including: a) a root cause for the identified pattern and b) a recommended action to remediate the root cause; and facilitate, using the processor, execution of the recommended action based on a trigger associated with the output.

### CROSS-REFERENCE TO RELATED APPLICATIONS

This application claims the benefit of U.S. Patent Application Ser. No. 61/988,736, filed May 5, 2014, which is incorporated herein by reference in its entirety for all purposes.

### FIELD OF DISCLOSURE

The present disclosure relates to knowledge-driven analytics, and more particularly to systems, methods and computer program products to provide actionable information and drive next course(s) of action through knowledge-driven analytics.

### BACKGROUND

The statements in this section merely provide background information related to the disclosure and may not constitute prior art.

Healthcare environments, such as hospitals or clinics, include information systems, such as hospital information systems (HIS), patient accounting systems, practice management systems, radiology information systems (RIS), clinical information systems (CIS), and cardiovascular information systems (CVIS), and storage systems, such as picture archiving and communication systems (PACS), library information systems (LIS), and electronic medical records (EMR). Information stored may include, for example, patient medication orders, medical histories, imaging data, test results, diagnosis information, billing and claims, payments, accounts receivable, management information, and/or scheduling information, for example.

### BRIEF DESCRIPTION

Certain examples provide a system including a memory storing instructions for execution; and a configured processor. The example processor is configured by executing the instructions stored in the memory to: identify, using the processor, a pattern in a data set using an analytic algorithm, the data set associated with a domain; process, using the processor, the identified pattern to assign a score to the identified pattern based on a comparison to statistical model meta data; construct, using the processor, a semantic model modeling people, processes, and systems associated with the domain; combine, using the processor, the identified pattern with the semantic model; determine, using the semantic model and the processor, an output including: a) a root cause for the identified pattern and b) a recommended action to remediate the root cause; and facilitate, using the processor, execution of the recommended action based on a trigger associated with the output.

Certain examples provide a non-transitory computer-readable storage medium including computer program instructions which, when executed by a processor, cause the processor to execute a method. The example method includes identifying, using the processor, a pattern in a data set using an analytic algorithm, the data set associated with a domain. The example method includes processing, using the processor, the identified pattern to assign a score to the identified pattern based on a comparison to statistical model meta data. The example method includes constructing, using the processor, a semantic model modeling people, processes, and systems associated with the domain. The example method includes combining, using the processor, the identified pattern with the semantic model. The example method includes determining, using the semantic model and the processor, an output including: a) a root cause for the identified pattern and b) a recommended action to remediate the root cause. The example method includes facilitating, using the processor, execution of the recommended action based on a trigger associated with the output.

Certain examples provide a computer-implemented method including identifying, using a processor, a pattern in a data set using an analytic algorithm, the data set associated with a domain. The example method includes processing, using the processor, the identified pattern to assign a score to the identified pattern based on a comparison to statistical model meta data. The example method also includes constructing, using the processor, a semantic model modeling people, processes, and systems associated with the domain. The example method includes combining, using the processor, the identified pattern with the semantic model. The example method includes determining, using the semantic model and the processor, an output including: a) a root cause for the identified pattern and b) a recommended action to remediate the root cause. The example method further includes facilitating, using the processor, execution of the recommended action based on a trigger associated with the output.

### BRIEF DESCRIPTION OF THE DRAWINGS

The features and technical aspects of the system and method disclosed herein will become apparent in the following Detailed Description set forth below when taken in conjunction with the drawings in which like reference numerals indicate identical or functionally similar elements.

FIG. 1 shows a block diagram of an example healthcare-focused information system.

FIG. 2 shows a block diagram of an example healthcare information infrastructure including one or more systems.

FIG. 3 shows an example industrial internet configuration including a plurality of health-focused systems.

FIG. 4 depicts an example knowledge-driven analytics system.

FIG. 5 illustrates an example differentiator output to provide, for a given scenario code, most significant contributing factors.

FIGS. 6-14 illustrate example actionable analytics interface views.

FIG. 15 illustrates an example knowledge-driven analytics system.

FIGS. 16-19 illustrate flow diagrams of example analytics methods to provide actionable information in accordance with the presently described and disclosed technology.

FIG. 20 illustrates an example visualization of a trend extracted from pattern(s) in data.

FIG. 21 shows a block diagram of an example processor system that can be used to implement systems and methods described herein.

### DETAILED DESCRIPTION OF CERTAIN EMBODIMENTS

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

### I. OVERVIEW

Healthcare delivery institutions are business systems that can be designed and operated to achieve their stated missions. There are benefits to managing variation such that the stake-holders within these business systems can focus more fully on the value added core processes that achieve the stated mission and less on activity responding to variations such as emergency procedures, regular medical interventions, delays, accelerations, backups, underutilized assets, unplanned overtime by staff and stock outs of material, equipment, people and space that are impacted in the course of delivering healthcare. Current healthcare information systems are data-driven in nature, proving, for example, deterministic procedural codes, schedules for rooms, people, materials, and equipment, and are not informative of the total cost, quality and access related to a care process to the patient, doctor, providers or payers. From the perspective of a provider of services, such as, for example a radiology department, better cost, quality and access related to a service can be provided if more information can be made available to the process stakeholders at the point of decision.

Data, information, and knowledge are overlapping but not necessarily identical items. While data represents raw numbers, information represents data of interest and knowledge represents information that is actionable. Not all data is information, and not all information is actionable.

Data-driven value creation provides visualization and analytics to address user pain points and reduce cognitive load to answer high value questions and create value. Data is collected, organized, analyzed, and understood to allow a user to strategize, choose, and preserve integrity, value, etc.

Aspects disclosed and described herein enable identification of unique patterns in healthcare data, using healthcare payment denials as an example. The patterns identify different problems or defects in processing of claims. The patterns point to or are closely associated with root causes of the denials. Once identified, automated methods are used to fix the denials and prevent them from occurring in the future. For example, certain aspects automatically identify similar or identical claims and thereby significantly narrow a number of disparate claims for a user to review. Groups of similar claims can be processed together, much more efficiently than identifying and processing claims individually.

Certain aspects compare metadata for one or more denial codes (referred to as an “in-set”) to a rest of the population (referred to as an “out-set”). Certain aspects use data mining techniques to identify set values in the metadata at which a frequency of occurrence between the in-set and the out-set is largest. Variables are sorted according to one or more “interestingness” criteria to easily and quickly identify most significant variables.

Certain aspects provide a data-driven approach to automatically identifying patterns of denials from healthcare payers. In certain aspects, healthcare providers (e.g., hospitals, clinics, etc.) and payers can identify key factors driving denials. Rather than manually exploring the data in a time-consuming fashion, automated processing can accelerate a lifetime of searching into a short series of processing operations, providing an identification of complex factors that is otherwise impossible if attempted manually. For example, a typical denials problem involving a month's worth of transaction data at a medium sized hospital provides between 10 million and 10 trillion potential combinations to check before identifying a pattern of denials. Under manual review, such analysis would take a person between ½ year to 300 years to perform the calculations involved using traditional techniques.

Certain aspects further streamline and simplify a denial resolution process. For example, a root cause can be identified by 1) providing tools, surfacing, and highlighting factors in an identified pattern of data and/or 2) providing automated reasoning to determine a root cause of a denial and action(s) to correct the problem. For example, an identified pattern includes one or more factors that can be viewed and processed to generate a hypothesis regarding where the problem in denials is occurring (e.g., the root cause of the denial). For example, when the pattern data shows that 30% of denials in the data set have occurred for OB/GYN (obstetrics/gynecology) visits to Dr. Smith when paid by Medicaid, an analysis of the data shows that denials have occurred due to incomplete documentation required by Medicaid for OB/GYN visits and a conclusion that Dr. Smith's office is not correctly completing and submitting the special documentation specified by Medicaid to cover OB/GYN visits. As another example, an automated reasoning or inference engine uses a semantic knowledge base to identify which pieces of data generated the denial and then automatically reasons to determine actions needed to correct the problem.

In certain examples, streamlining of the denial resolution process stems at least in part from not having to research a context of a denial. Instead, the pattern identifies which few factors are critical in the analysis and make the denials unusual. Additionally, denials in a pattern can be analyzed as a group, rather than being worked one at a time, because the denials share common attribute(s). When a new pattern is spotted, an alert is generated so that a response can be promptly generated rather than allowing the problem to linger and extend. In some examples, the pattern can be flagged so that if the pattern occurs again, the problem is automatically routed to an appropriate solution workflow.

Certain aspects utilize 1) one or more algorithms to identify patterns and 2) semantic models of people, business processes, and computer systems to assist in identification of root causes and recommendations associated with claim denials. For example, one or more statistical algorithms such as linear regression, logistic regression, non-linear regression, principle components, etc., can be used to identify pattern(s) in the data. Alternatively or in addition, one or more data mining and/or machine learning algorithms such as support vector machines, artificial neural networks, hierarchical clustering, linear discriminant analysis, contrast set mining, separating hyperplanes, decision trees, Bayesian analysis, linear classifiers, association rules, self-organizing maps, random forests, etc., can be used to identify pattern(s) in the data. Further, one or more database structured query language (SQL) methods such as aggregation, online analytical processing (OLAP) cubes, etc. can be used to identify pattern(s) in the data. Certain aspects automatically assign denials to appropriate task management and workflow systems, create new transaction edits to be used in preprocessing future claims, and/or automatically write-off and/or transfer denied amounts to another payer and/or patient in a patient accounting system, etc.

Certain aspects use a set of algorithms to build a model of expected behavior for a conditional/causal variable. Model building marginal estimation and association rules with one or more methods such as statistical algorithms, data mining and/or machine learning algorithms, and/or database methods outlined above, for example, are provided to model an expected response.

Factors and associated observations can be gathered based on identified pattern(s) and rule(s). In certain examples, for the methods listed above, for each identified rule or pattern, one or more parent rules having more factors and covering all or most of the same observations can be identified to determine the most broadly applicable rule(s) for the pattern(s). Once rule(s) and/or pattern(s) have been created, the rules can be grouped into rule set(s) in which a rule set includes one or more rules having the same factor(s).

Other aspects, such as those discussed in the following and others as can be appreciated by one having ordinary skill in the art upon reading the enclosed description, are also possible.

### II. EXAMPLE OPERATING ENVIRONMENT

Health information, also referred to as healthcare information and/or healthcare data, relates to information generated and/or used by a healthcare entity. Health information can be information associated with health of one or more patients, for example. Health information may include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient PHI and employee information between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information, operations management, and services. Such an infrastructure may include a centralized capability including, for example, a data repository, reporting, discreet data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and related healthcare operations staff, as well as helps improve an administrative and management burden on the patient for managing his or her care. Particularly, interconnecting the patient's electronic medical record, administrative, and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. Example SOA includes a three-fold interoperability strategy including a central repository (e.g., a central repository built from Health Level Seven (HL7) transactions and/or ANSI X12N transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, CPT, X12, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients or sets of operational data. Dashboard(s) can be based on condition, role, and/or other criteria to indicate variation(s) from a desired practice, for example.

A. Example Healthcare Information System

An information system can be defined as an arrangement of information/data, processes, and information technology that interact to collect, process, store, and provide informational output to support delivery of healthcare to one or more patients. Information technology includes computer technology (e.g., hardware and software) along with data and telecommunications technology (e.g., data, image, and/or voice network, etc.).

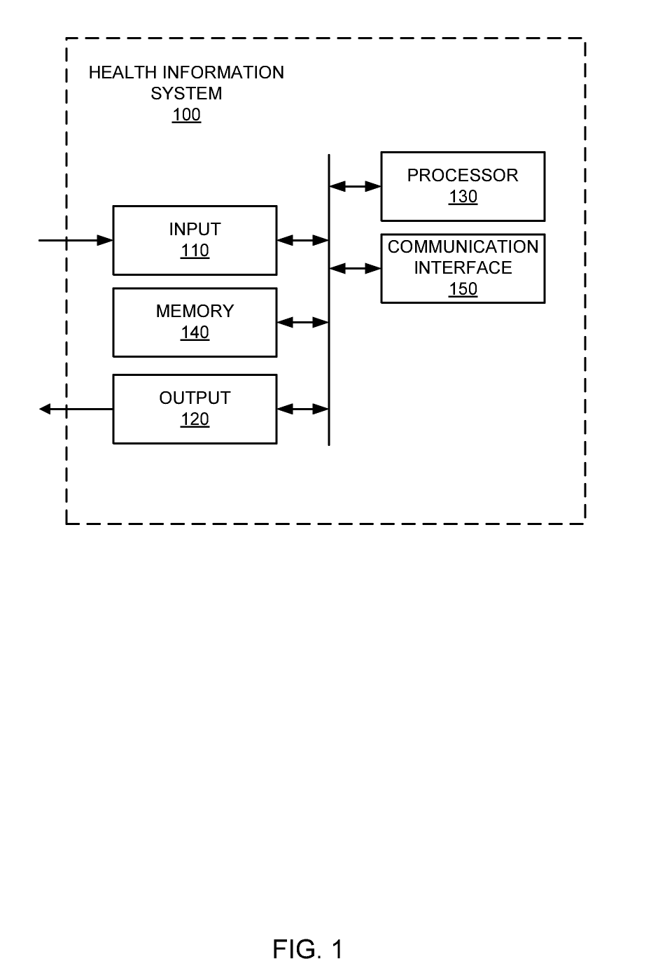

Turning now to the figures, FIG. 1 shows a block diagram of an example healthcare-focused information system 100. Example system 100 can be configured to implement a variety of systems and processes including image storage (e.g., picture archiving and communication system (PACS), etc.), image processing and/or analysis, radiology reporting and/or review (e.g., radiology information system (RIS), etc.), computerized provider order entry (CPOE) system, clinical decision support, patient monitoring, population health management (e.g., population health management system (PHMS), health information exchange (HIE), etc.), healthcare data analytics, cloud-based image sharing, electronic medical record (e.g., electronic medical record system (EMR), electronic health record system (EHR), electronic patient record (EPR), personal health record system (PHR), etc.), and/or other health information system (e.g., clinical information system (CIS), hospital information system (HIS), patient data management system (PDMS), laboratory information system (LIS), cardiovascular information system (CVIS), patient accounting, practice management (PM), etc.

As illustrated in FIG. 1, the example information system 100 includes an input 110, an output 120, a processor 130, a memory 140, and a communication interface 150. The components of example system 100 can be integrated in one device or distributed over two or more devices.

Example input 110 may include a keyboard, a touch-screen, a mouse, a trackball, a track pad, optical barcode recognition, voice command, etc. or combination thereof used to communicate an instruction or data to system 100. Example input 110 may include an interface between systems, between user(s) and system 100, etc.

Example output 120 can provide a display generated by processor 130 for visual illustration on a monitor or the like. The display can be in the form of a network interface or graphic user interface (GUI) to exchange data, instructions, or illustrations on a computing device via communication interface 150, for example. Example output 120 may include a monitor (e.g., liquid crystal display (LCD), plasma display, cathode ray tube (CRT), etc.), light emitting diodes (LEDs), a touch-screen, a printer, a speaker, a mobile device (e.g., tablet, phone, etc.) display, or other conventional display device or combination thereof.

Example processor 130 includes hardware and/or software configuring the hardware to execute one or more tasks and/or implement a particular system configuration. Example processor 130 processes data received at input 110 and generates a result that can be provided to one or more of output 120, memory 140, and communication interface 150. For example, example processor 130 can take user annotation provided via input 110 with respect to an image displayed via output 120 and can generate a report associated with the image based on the annotation. As another example, processor 130 can process updated patient information obtained via input 110 to provide an updated patient record to an EMR or management system via communication interface 150.

Example memory 140 may include a relational database, an object-oriented database, a data dictionary, a clinical data repository, a data warehouse, a data mart, a vendor neutral archive, an enterprise archive, etc. Example memory 140 stores images, patient data, operations and management data, best practices, clinical knowledge, analytics, reports, etc. Example memory 140 can store data and/or instructions for access by the processor 130. In certain examples, memory 140 can be accessible by an external system via the communication interface 150.

In certain examples, memory 140 stores and controls access to encrypted information, such as patient records, encrypted update-transactions for patient medical records, including usage history, etc. In an example, medical records can be stored without using logic structures specific to medical records. In such a manner, memory 140 is not searchable. For example, a patient's data can be encrypted with a unique patient-owned key at the source of the data. The data is then uploaded to memory 140. Memory 140 does not process or store unencrypted data thus minimizing privacy concerns. The patient's data can be downloaded and decrypted locally with the encryption key.

For example, memory 140 can be structured according to provider, patient, patient/provider association, and document. Provider information may include, for example, an identifier, a name, and address, a public key, and one or more security categories. Patient information may include, for example, an identifier, a password hash, and an encrypted email address. Patient/provider association information may include a provider identifier, a patient identifier, an encrypted key, and one or more override security categories. Document information may include an identifier, a patient identifier, a clinic identifier, a security category, and encrypted data, for example.

Example communication interface 150 facilitates transmission of electronic data within and/or among one or more systems. Communication via communication interface 150 can be implemented using one or more protocols. In some examples, communication via communication interface 150 occurs according to one or more standards (e.g., Digital Imaging and Communications in Medicine (DICOM), Health Level Seven (HL7), ANSI X12N, etc.). Example communication interface 150 can be a wired interface (e.g., a data bus, a Universal Serial Bus (USB) connection, etc.) and/or a wireless interface (e.g., radio frequency, infrared, near field communication (NFC), etc.). For example, communication interface 150 may communicate via wired local area network (LAN), wireless LAN, wide area network (WAN), etc. using any past, present, or future communication protocol (e.g., BLUETOOTH™, USB 2.0, USB 3.0, etc.).

In certain examples, a Web-based portal may be used to facilitate access to information, patient care and/or practice management, etc. Information and/or functionality available via the Web-based portal may include one or more of order entry, laboratory test results review system, patient information, clinical decision support, medication management, scheduling, electronic mail and/or messaging, medical resources, revenue cycle management, etc. In certain examples, a browser-based interface can serve as a zero footprint, zero download, and/or other universal viewer for a client device.

In certain examples, the Web-based portal serves as a central interface to access information and applications, for example. Data may be viewed through the Web-based portal or viewer, for example. Additionally, data may be manipulated and propagated using the Web-based portal, for example. Data may be generated, modified, stored and/or used and then communicated to another application or system to be modified, stored and/or used, for example, via the Web-based portal, for example.

The Web-based portal may be accessible locally (e.g., in an office) and/or remotely (e.g., via the Internet and/or other private network or connection), for example. The Web-based portal may be configured to help or guide a user in accessing data and/or functions to facilitate patient care and hospital or practice management, for example. In certain examples, the Web-based portal may be configured according to certain rules, preferences and/or functions, for example. For example, a user may customize the Web portal according to particular desires, preferences and/or requirements.

B. Example Healthcare Infrastructure

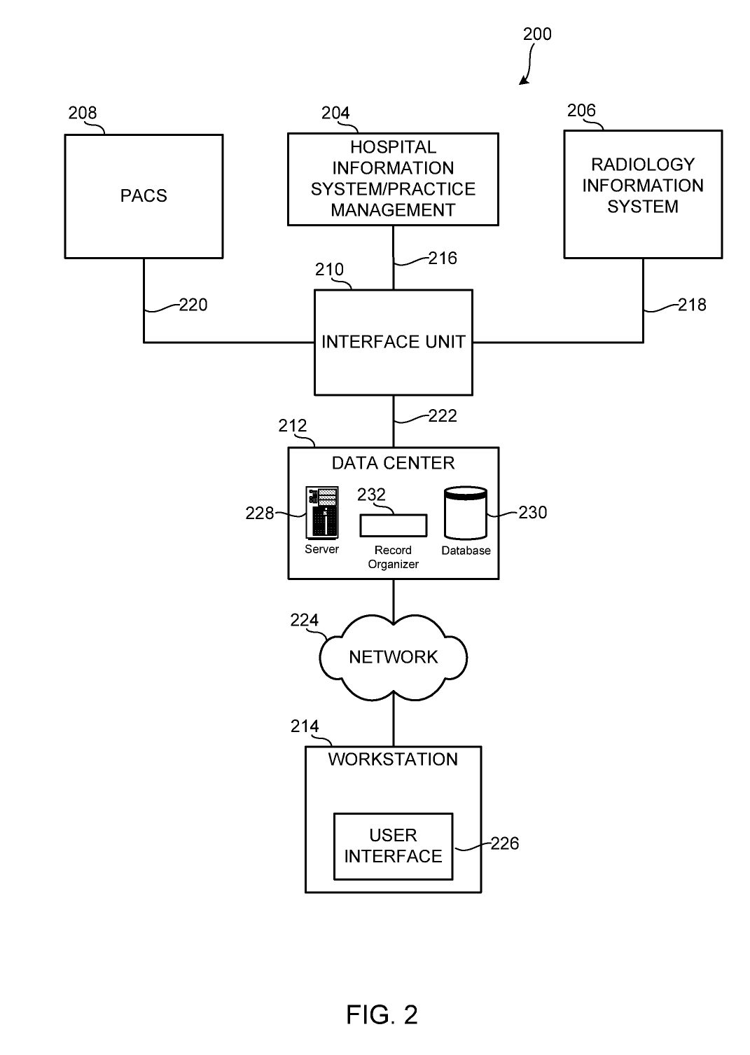

FIG. 2 shows a block diagram of an example healthcare information infrastructure 200 including one or more subsystems such as the example healthcare-related information system 100 illustrated in FIG. 1. Example healthcare system 200 includes a HIS/PM 204, a RIS 206, a PACS 208, an interface unit 210, a data center 212, and a workstation 214. In the illustrated example, HIS 204, RIS 206, and PACS 208 are housed in a healthcare facility and locally archived. However, in other implementations, HIS 204, RIS 206, and/or PACS 208 may be housed within one or more other suitable locations. In certain implementations, one or more of PACS 208, RIS 206, HIS 204, etc., may be implemented remotely via a thin client and/or downloadable software solution. Furthermore, one or more components of the healthcare system 200 can be combined and/or implemented together. For example, RIS 206 and/or PACS 208 can be integrated with HIS 204; PACS 208 can be integrated with RIS 206; and/or the three example information systems 204, 206, and/or 208 can be integrated together. In other example implementations, healthcare system 200 includes a subset of the illustrated information systems 204, 206, and/or 208. For example, healthcare system 200 may include only one or two of HIS 204, RIS 206, and/or PACS 208. Information (e.g., scheduling, test results, exam image data, observations, diagnosis, billing data, etc.) can be entered into HIS 204, RIS 206, and/or PACS 208 by healthcare practitioners (e.g., radiologists, physicians, and/or technicians) and/or administrators before and/or after patient examination.

The HIS 204 stores medical information such as clinical reports, patient information, administrative information received from, for example, personnel at a hospital, clinic, and/or a physician's office (e.g., an EMR, EHR, PHR, etc.), and/or billing/payment information received from a payer or clearinghouse. RIS 206 stores information such as, for example, radiology reports, radiology exam image data, messages, warnings, alerts, patient scheduling information, patient demographic data, patient tracking information, and/or physician and patient status monitors. Additionally, RIS 206 enables exam order entry (e.g., ordering an x-ray of a patient) and image and film tracking (e.g., tracking identities of one or more people that have checked out a film). In some examples, information in RIS 206 is formatted according to the HL-7 (Health Level Seven) clinical communication protocol. In certain examples, a medical exam distributor is located in RIS 206 to facilitate distribution of radiology exams to a radiologist workload for review and management of the exam distribution by, for example, an administrator.

PACS 208 stores medical images (e.g., x-rays, scans, three-dimensional renderings, etc.) as, for example, digital images in a database or registry. In some examples, the medical images are stored in PACS 208 using the Digital Imaging and Communications in Medicine (DICOM) format. Images are stored in PACS 208 by healthcare practitioners (e.g., imaging technicians, physicians, radiologists) after a medical imaging of a patient and/or are automatically transmitted from medical imaging devices to PACS 208 for storage. In some examples, PACS 208 can also include a display device and/or viewing workstation to enable a healthcare practitioner or provider to communicate with PACS 208.

The interface unit 210 includes a hospital information system interface connection 216, a radiology information system interface connection 218, a PACS interface connection 220, and a data center interface connection 222. Interface unit 210 facilities communication among HIS 204, RIS 206, PACS 208, and/or data center 212. Interface connections 216, 218, 220, and 222 can be implemented by, for example, a Wide Area Network (WAN) such as a private network or the Internet. Accordingly, interface unit 210 includes one or more communication components such as, for example, an Ethernet device, an asynchronous transfer mode (ATM) device, an 802.11 device, a DSL modem, a cable modem, a cellular modem, etc. In turn, the data center 212 communicates with workstation 214, via a network 224, implemented at a plurality of locations (e.g., a hospital, clinic, doctor's office, other medical office, or terminal, etc.). Network 224 is implemented by, for example, the Internet, an intranet, a private network, a wired or wireless Local Area Network, and/or a wired or wireless Wide Area Network. In some examples, interface unit 210 also includes a broker (e.g., a Mitra Imaging's PACS Broker) to allow medical information and medical images to be transmitted together and stored together.

Interface unit 210 receives images, medical reports, administrative information, exam workload distribution information, and/or other clinical information from the information systems 204, 206, 208 via the interface connections 216, 218, 220. If necessary (e.g., when different formats of the received information are incompatible), interface unit 210 translates or reformats (e.g., into Structured Query Language (“SQL”) or standard text) the medical information, such as medical reports, to be properly stored at data center 212. The reformatted medical information can be transmitted using a transmission protocol to enable different medical information to share common identification elements, such as a patient name or social security number. Next, interface unit 210 transmits the medical information to data center 212 via data center interface connection 222. Finally, medical information is stored in data center 212 in, for example, the DICOM format, which enables medical images and corresponding medical information to be transmitted and stored together.

The medical information is later viewable and easily retrievable at workstation 214 (e.g., by their common identification element, such as a patient name or record number). Workstation 214 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. Workstation 214 receives commands and/or other input from a user via, for example, a keyboard, mouse, track ball, microphone, etc. Workstation 214 is capable of implementing a user interface 226 to enable a healthcare practitioner and/or administrator to interact with healthcare system 200. For example, in response to a request from a physician, user interface 226 presents a patient medical history. In other examples, a radiologist is able to retrieve and manage a workload of exams distributed for review to the radiologist via user interface 226. In further examples, an administrator reviews radiologist workloads, exam allocation, and/or operational statistics associated with the distribution of exams via user interface 226. In some examples, the administrator adjusts one or more settings or outcomes via user interface 226.

Example data center 212 of FIG. 2 is an archive to store information such as images, data, medical reports, and/or, more generally, patient medical records. In addition, data center 212 can also serve as a central conduit to information located at other sources such as, for example, local archives, hospital information systems/radiology information systems (e.g., HIS 204 and/or RIS 206), or medical imaging/storage systems (e.g., PACS 208 and/or connected imaging modalities). That is, the data center 212 can store links or indicators (e.g., identification numbers, patient names, or record numbers) to information. In the illustrated example, data center 212 is managed by an application server provider (ASP) and is located in a centralized location that can be accessed by a plurality of systems and facilities (e.g., hospitals, clinics, doctor's offices, other medical offices, and/or terminals). In some examples, data center 212 can be spatially distant from HIS 204, RIS 206, and/or PACS 208.

Example data center 212 of FIG. 2 includes a server 228, a database 230, and a record organizer 232. Server 228 receives, processes, and conveys information to and from the components of healthcare system 200. Database 230 stores the medical information described herein and provides access thereto. Example record organizer 232 of FIG. 2 manages patient medical histories, for example. Record organizer 232 can also assist in procedure scheduling, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray image into the cloud-based clinical information system, and the second clinician may view the x-ray image via a web browser and/or download the x-ray image onto a local information system employed by the second clinician.

As another example, a cloud-based analytics system (e.g., a cloud-based electronic data interchange (EDI) and/or other analytics system) performs an analysis of operational data and provides results back to a management system(s).

In certain examples, users (e.g., a patient and/or care provider) can access functionality provided by system 200 via a software-as-a-service (SaaS) implementation over a cloud or other computer network, for example. In certain examples, all or part of system 200 can also be provided via platform as a service (PaaS), infrastructure as a service (IaaS), etc. For example, system 200 can be implemented as a cloud-delivered Mobile Computing Integration Platform as a Service. A set of consumer-facing Web-based, mobile, and/or other applications enable users to interact with the PaaS, for example.

C. Industrial Internet Examples

The Internet of things (also referred to as the “Industrial Internet”) relates to an interconnection between a device that can use an Internet connection to talk with other devices on the network. Using the connection, devices can communicate to trigger events/actions (e.g., changing temperature, turning on/off, providing a status, etc.). In certain examples, machines can be merged with “big data” to improve efficiency and operations, provide improved data mining, facilitate better operation, etc.

Big data can refer to a collection of data so large and complex that it becomes difficult to process using traditional data processing tools/methods. Challenges associated with a large data set include data capture, sorting, storage, search, transfer, analysis, and visualization. A trend toward larger data sets is due at least in part to additional information derivable from analysis of a single large set of data, rather than analysis of a plurality of separate, smaller data sets. By analyzing a single large data set, correlations can be found in the data, and data quality can be evaluated. For example, large volumes of operational and EDI data are stored in an EDI clearinghouse and can benefit from automated big data analysis to identify correlations and evaluations impractical for a human user.

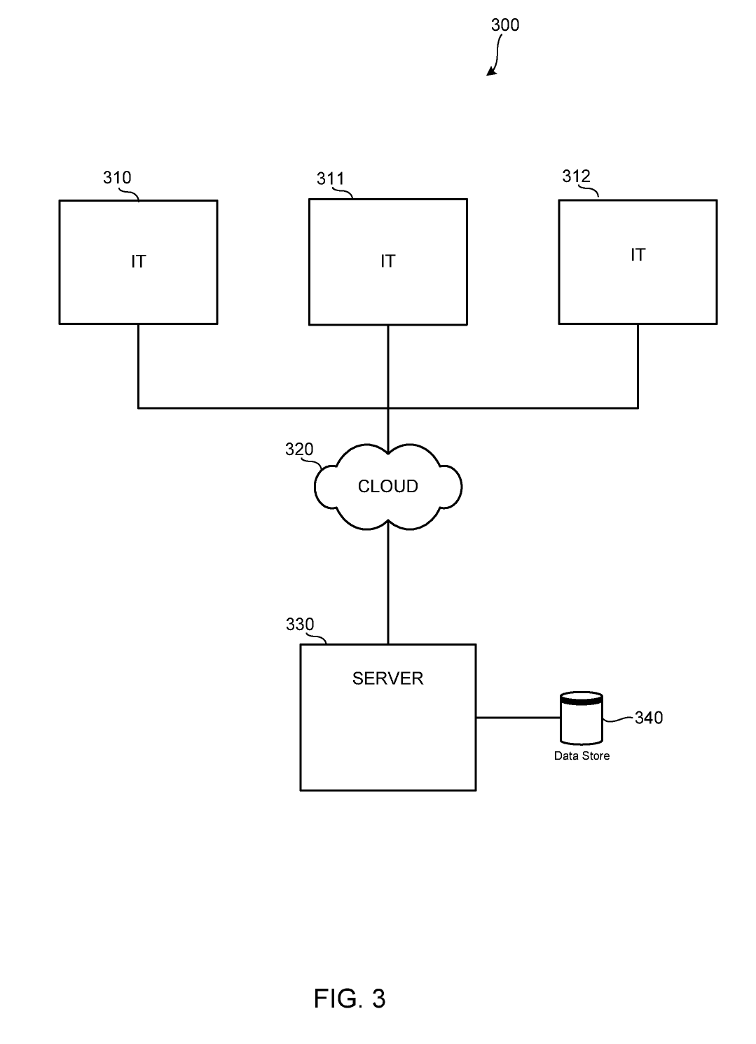

FIG. 3 illustrates an example industrial internet configuration 300. Example configuration 300 includes a plurality of health-focused systems 310-312, such as a plurality of health information systems 100 (e.g., PACS, RIS, EMR, etc.) communicating via industrial internet infrastructure 300. Example industrial internet 300 includes a plurality of health-related information systems 310-312 communicating via a cloud 320 with a server 330 and associated data store 340.

As shown in the example of FIG. 3, a plurality of devices (e.g., information systems, imaging modalities, etc.) 310-312 can access a cloud 320, which connects the devices 310-312 with a server 330 and associated data store 340. Information systems, for example, include communication interfaces to exchange information with server 330 and data store 340 via the cloud 320. Other devices, such as medical imaging scanners, patient monitors, etc., can be outfitted with sensors and communication interfaces to enable them to communicate with each other and with the server 330 via the cloud 320.

Thus, machines 310-312 within system 300 become “intelligent” as a network with advanced sensors, controls, and software applications. Using such an infrastructure, advanced analytics can be provided to associated data. The analytics combines physics-based analytics, predictive algorithms, automation, and deep domain expertise. Via cloud 320, devices 310-312 and associated people can be connected to support more intelligent design, operations, maintenance, and higher server quality and safety, for example.

Using the industrial internet infrastructure, for example, a proprietary machine data stream can be extracted from a device 310. Machine-based algorithms and data analysis are applied to the extracted data. Data visualization can be remote, centralized, etc. Data is then shared with authorized users, and any gathered and/or gleaned intelligence is fed back into the machines 310-312.

D. Data Mining Examples

Imaging informatics includes determining how to tag and index a large amount of data acquired in diagnostic imaging in a logical, structured, and machine-readable format. By structuring data logically, information can be discovered and utilized by algorithms that represent clinical pathways and decision support systems. Data mining can be used to help ensure patient safety, reduce disparity in treatment, provide clinical decision support, etc. Data mining can also be used with respect to large volumes of operational and EDI data, for example. Mining both structured and unstructured data from radiology reports, as well as actual image pixel data, can be used to tag and index both imaging reports and the associated images themselves.

E. Example Methods of Use

Clinical workflows are typically defined to include one or more steps or actions to be taken by the system in response to one or more identified events and/or according to a schedule. Events may include receiving a healthcare message associated with one or more aspects of a clinical record, opening a record(s) for new patient(s), receiving a transferred patient, reviewing and reporting on an image, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, radiology image reading, and/or any other action useful in processing healthcare information. The defined clinical workflows may include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

In certain examples, a medical exam conducted on a patient can involve review by a healthcare practitioner, such as a radiologist, to obtain, for example, diagnostic information from the exam. In a hospital setting, medical exams can be ordered for a plurality of patients, all of which require review by an examining practitioner. Each exam has associated attributes, such as a modality, a part of the human body under exam, and/or an exam priority level related to a patient criticality level. Hospital administrators, in managing distribution of exams for review by practitioners, can consider the exam attributes as well as staff availability, staff credentials, and/or institutional factors such as service level agreements and/or overhead costs.

Additional workflows can be facilitated such as bill processing, revenue cycle mgmt., population health management, patient identity, consent management, etc. For example, revenue cycle workflows can be defined to include one or more actions to be taken in response to one or more events based on a responsible party to make a payment for a service provided to a patient. The responsible party may be one or more specific payers based on a combination of date and type of service.

Workflow actions in a collection of payment for a service provided to a patient include: confirming a correct payer through eligibility checking; coding services with appropriate procedure codes, modifiers codes and diagnosis codes, along with correct identifiers for the patient, and providers and facilities involved; determining if a prior to service authorization is required to be obtained for a specific service or provider, and then obtaining the authorization; creating an ANSI X12N claim transaction that includes all information in correct format; and submitting a claim transaction to a correct payer and within timely filing limits from the patient accounting accounts receivable system for each invoice and related services. Remittance data is received from the payer that includes payment and adjustment or denial amounts. The remittance data is posted to the correct invoice in accounts receivable. Denials for services not paid are handled, which includes understanding denial reasons, potential cause, etc. The workflow determines whether to follow-up on the denial with the payer, and, if appropriate, handles the follow-up, which repeats the cycle again.

### III. EXAMPLE ANALYTICS SYSTEM

Example systems facilitate discovery of patterns in data. Data mining, machine learning, and knowledge discovery can be provided to drive effective, data-driven decision making. In certain aspects, data is imported and used to benchmark high value questions. Analytics are applied to automatically discover hidden patterns in the data. Visualization of the identified patterns provides insight and recommendation to a user. In some examples, visualization helps a user and/or the system take action to identify, plan, and execute a response. Certain examples can apply to a variety of technological fields including healthcare, finance, Industrial Internet, etc.

Certain aspects focus on denials (e.g., made to health insurance claims) for a healthcare institution and/or network (e.g., hospital, clinic, doctor's office, hospital network, etc.). Certain examples provide algorithms to build a model of expected behavior for a selected conditional variable (e.g., one or more operational variables such as one or more denial codes, etc.). Certain examples facilitate model building marginal estimation and association rules with one or more data analytics methods.

For example, one or more statistical algorithms such as linear regression, logistic regression, non-linear regression, principle components, etc., can be used to identify pattern(s) in the data. Alternatively or in addition, one or more data mining and/or machine learning algorithms such as support vector machines, artificial neural networks, hierarchical clustering, linear discriminant analysis, contrast set mining, separating hyperplanes, decision trees, Bayesian analysis, linear classifiers, association rules, self-organizing maps, random forests, etc., can be used to identify pattern(s) in the data. Further, one or more database structured query language (SQL) methods such as aggregation, online analytical processing (OLAP) cubes, etc. can be used to identify pattern(s) in the data.

Factors and associated observations can be gathered based on identified pattern(s) and rule(s). In certain examples, for the methods listed above, for each identified rule or pattern, one or more parent rules having more factors and covering all or most of the same observations can be identified to determine the most broadly applicable rule(s) for the pattern(s). Once rule(s) and/or pattern(s) have been created, the rules can be grouped into rule set(s) in which a rule set includes one or more rules having the same factor(s).

Certain aspects interrelate people, processes, and technology both at a healthcare provider and a payer to facilitate action on denials. In certain examples, technology provides analytics, visualization, and semantics to characterize denial costs and return on investment, discover patterns in denials, identify root causes/problems, recommend actions to fix current problems, recommend changes to avoid future problems, identify and response to emerging trends, etc.

Electronic data interchange (EDI) provides claim and remittance processing between a provider and a payer. A defect can be introduced at a variety of points in the process between provider and payer. A provider has many high value questions regarding denials including: 1) What can I do to increase my revenue and decrease a number of denials? 2) What are root causes of my denials? 3) What can I do to avoid denials in the future? Rather than an impractical, unworkable manual review, certain examples provide an automated analysis.

An analysis of denials for a medium size provider network can provide an opportunity benchmark of dollars per claim and an identification of payer and provider attribute combinations that have unexpectedly high rates of denials. An opportunity benchmark measures an amount of value to an enterprise if a problem can be addressed. An opportunity benchmark equals an opportunity cost, for example. For a denial, an opportunity benchmark equals a denied cost plus a cost of labor to fix.

Pattern discovery is conducted to identify patterns from historic data to detect anomalies and then to identify root causes of detected anomalies. Contrast set mining and/or other statistical algorithm, data mining and/or machine learning algorithm, and/or database method, for example, can be used to identify a set of rules that describe what makes a group different (e.g., what is different about things that are defective). Historic events can be characterized. A present situation can be compared to what happened in the past. An analysis of how future outcomes can improve is also provided.

Insight can be discovered from the data using analytics to provide actionable, targeted information. Root causes and resolutions can be identified to help fix denials before they happen and/or automatically resolve denials. Complex relationships can be discovered using automated analytics (e.g., payer, division, group, specialty, individual provider, hospital, etc.). Prior authorization, credentialing, etc., can be reviewed to provide specific, dynamic, and data driven information. Output can be visualized for review, selection, and action, for example. In some examples, an output report can be generated for a user based on the provided analysis.

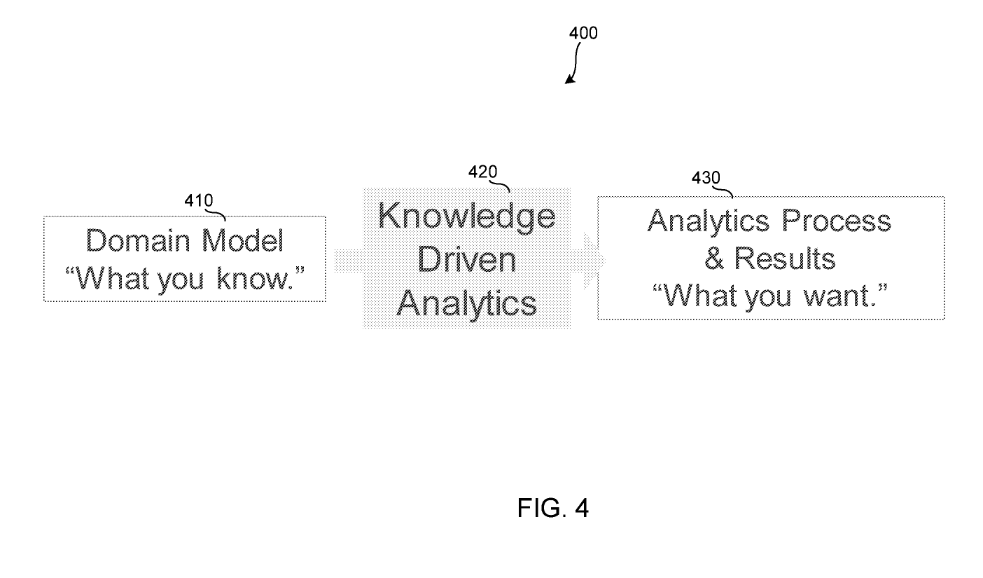

FIG. 4 depicts an example knowledge-driven analytics system 400 including a domain model 410, knowledge-driven analytics 420, and analytics process and results 430. Semantics guides the exploration, builds analytic models, and captures expert knowledge. EDI services facilitate data exchange and processing to map patient services with claims, payer information, denials, and associated causes and recommendation, for example.

For example, analytics and visualization describe how different variable relate to each other. Analytics and visualization identify variables related to a variable of interest. Analytics and visualization build a statistical model of Y=f(x). Analytics and visualization evaluate the model to make a prediction. Analytics and visualization apply the model to reshape the prediction to be useful. Analytics and visualization calculate errors, ratios, and deltas between a prediction and observed data. Analytics and visualization visualizes and presents the results.

In certain examples, knowledge driven analytics provide a knowledge model and an analytic model. The example knowledge model describes a problem and analysis goals. The knowledge model includes objects, properties, and relationships. The analytic model performs reasoning/inference and execution. The analytic model includes analytics and process. Knowledge models or knowledge bases can be mapped to an EDI database. Certain examples provide an extensible platform for data analysis and visualization to identify potential factor, build a statistical model, evaluate the statistical model, and auto-visualize results.

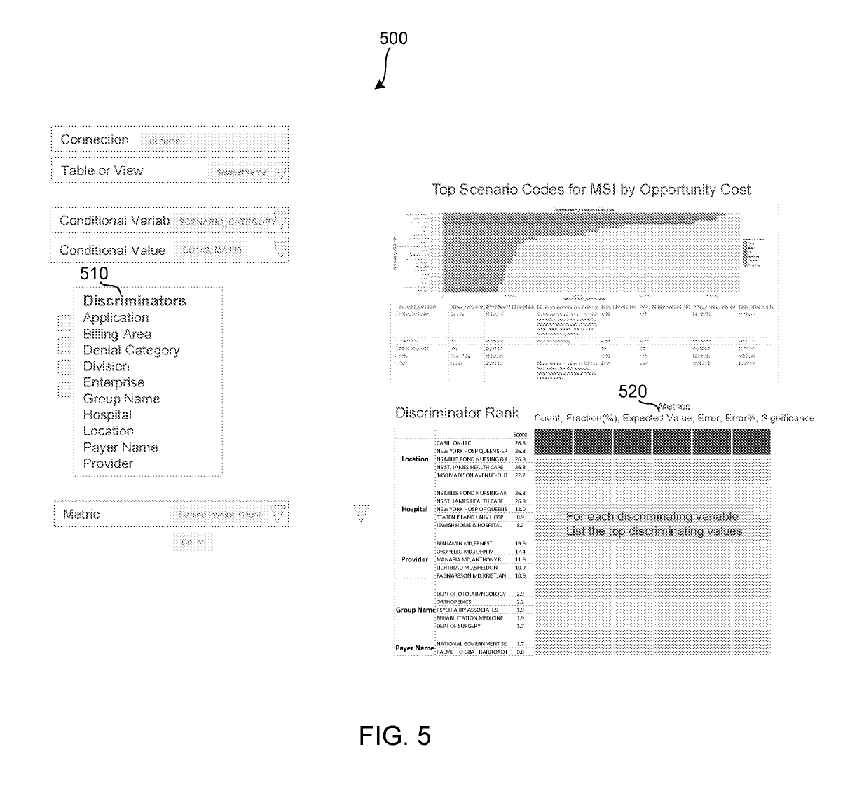

FIG. 5 illustrates an example differentiator output 500 to provide, for a given scenario code, most significant contributing factors. The differentiator 500 provides a difference finder showing top scenario codes by opportunity cost, discriminator rank, and/or other visual analytics. Using the example differentiator tool 500, historical data and patterns are reviewed to identify root causes for an anomaly. For example, benchmarks with most active denial scenario codes and most dollars at stake can be reviewed to identify root cause(s) of associated problem(s). For a given scenario code, most significant contributing factor(s) are automatically identified.

The example differentiator 500 can be used to process a condition (e.g., an item or “thing” that is to be explained). The condition can be based on and/or identified by a scenario code (e.g., “When does scenario code CO140,MA130,MA61 occur most frequently”, etc.), for example. The differentiator 500 identifies potential root cause(s) associated with one or more discriminating variables 510 indicating where to look for problems. For example, discriminating variables 510 identifying potential root causes of a claim denial can include application, billing area, denial category, division, enterprise, group name, hospital, location, payer name, provider, procedure (e.g., CPT, etc.) and modifier code, diagnosis code (e.g., ICD9, ICD10, etc.), etc. For example, discriminators 510 can be used to formulate a question such as “what is different about claims with scenario code CO140,MA130,MA61 compared to the rest of the population?”.

Metrics 520 provide a gauge of how significance is measured. For example, metrics 520 can be used to describe or quantify what is important to a customer. Metrics 520 can be measured by one or more criteria such as denial count, opportunity cost, percentage of denied charges, rework cost, etc. Metrics 520 can be scored by total amount (e.g., sum), average percent, unexpectedness, etc. (e.g., a measure of “how much different are they?”). While the differentiator 500 is illustrated in the example context of denials, the differentiator 500 can be applied to other high value questions as well.

Using pattern discovery, patterns from historic data can be identified and used to identify root causes of a problem (e.g., claim denials). One or more statistical algorithm(s), data mining and/or machine learning algorithm(s), database SQL method(s), etc., such as contrast set mining, allow the systems and methods to discover a set of rules that describe what makes a group different. For example, contrast set mining can be used to identify what is different about a group of items that is defective versus another group that is not defective. To determine one or more meaningful or substantive differences between contrasting groups, a condition is defined along with factor(s) modifying that condition and metric(s) quantifying and/or otherwise measuring that condition based on the factor(s). For example, a condition can be defined as “what is different about condition X”. A factor qualifying that condition can be defined as “how the condition is different.” A metric to measure the condition based on the factor can be defined as “a magnitude of the difference.” Contrast set mining can be applied to characterize historic events (e.g., past), examine a difference in current versus past situation (e.g., present), and predict path(s) for improvement in outcome (e.g., future). Contrast set mining can be facilitated by certain aspects and provided to a user via an interactive dashboard providing information to the user for further exploration and corrective action, for example.

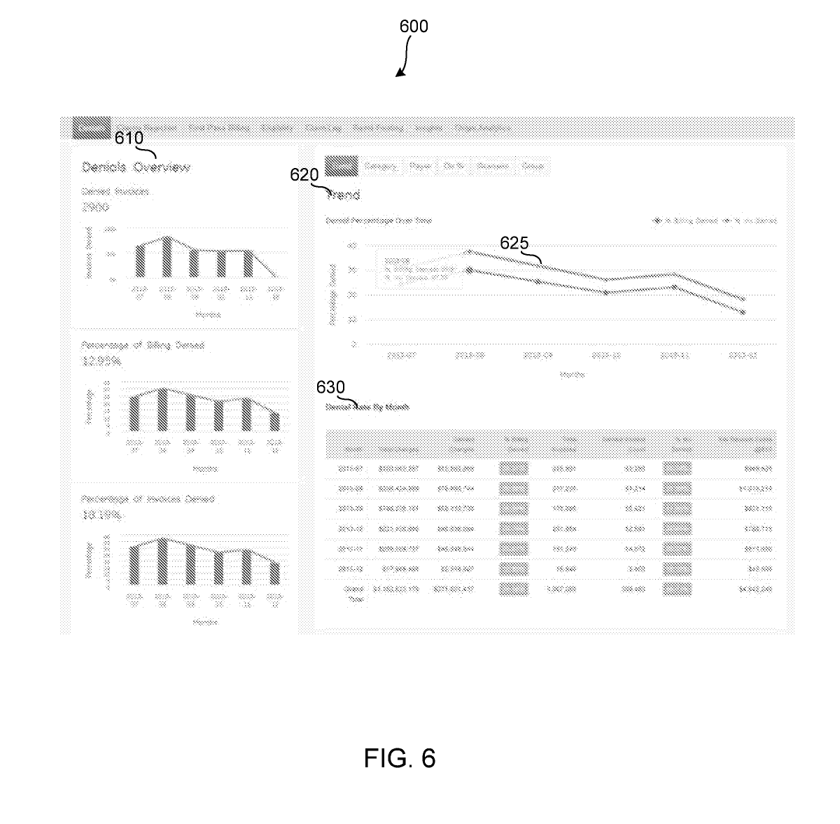

FIG. 6 illustrates an example revenue cycle analytics dashboard 600. Data mining is combined with semantics to identify potential root causes for denials, and resulting visualization and interactivity are provided via the dashboard 600. The example dashboard 600 provides an overview and a launching point to review and drill through from overall denial trending to particular denial information.

Using the example dashboard 600, specific categories can be reviewed to assess most significant areas of opportunity by dollar and count, with an added ability to filter down to areas that a user wishes to better understand. For example, the dashboard 600 provides an overview 610 of invoice denials. A user can view additional information such as a trend 620 in denial percentage over time, denial rate 630 by month, etc. Selecting or hovering over a particular item (e.g., a point on the trend graph 625) provides additional information to the user, for example.

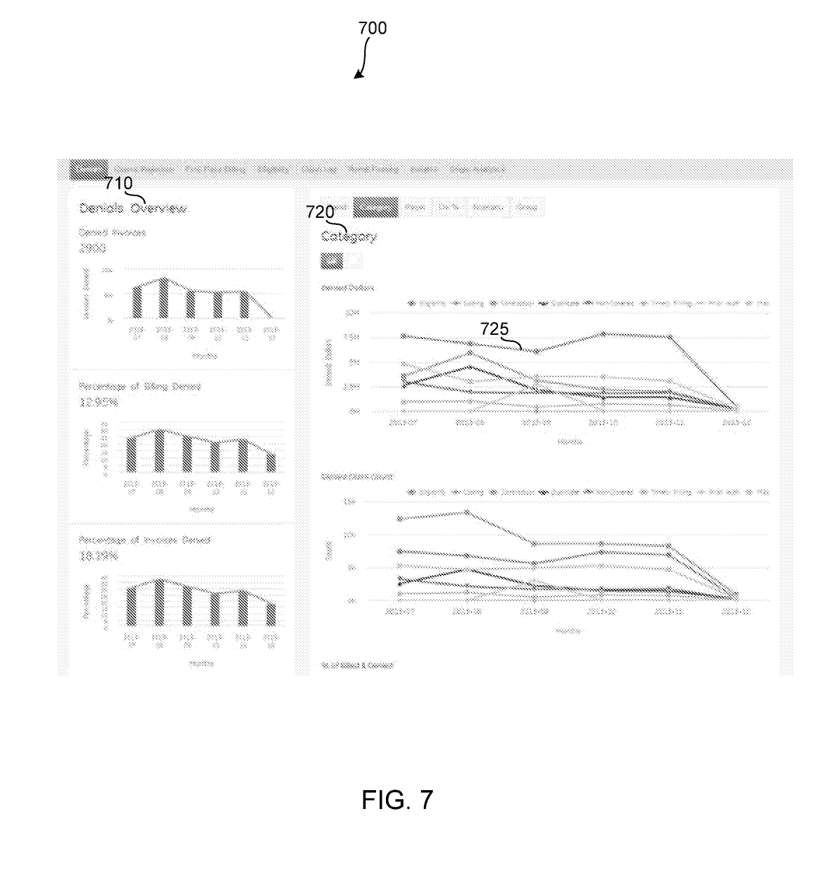

As shown in the example of FIG. 7, an example interface 700 provides overview one or more denial categories of interest 720 can be selected with a few clicks of a mouse and/or other pointing/cursor control device selecting and/or hovering over a point on a graph and/or other indication 725 of category information 720 (e.g., denied dollars, denied claim count, etc.).

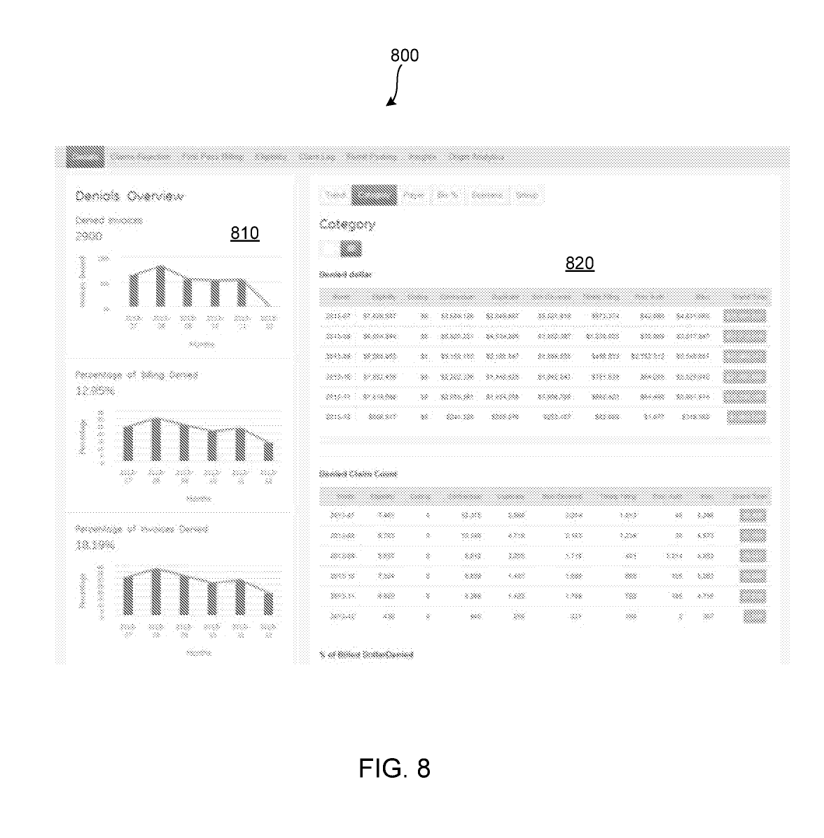

As shown in the example of FIG. 8, using an interface 800, a user can toggle between a graphical rendering of the information 720 and a view of actual data points provided in a table view with more specific detail 820 for various categories as well as view overview information 810.

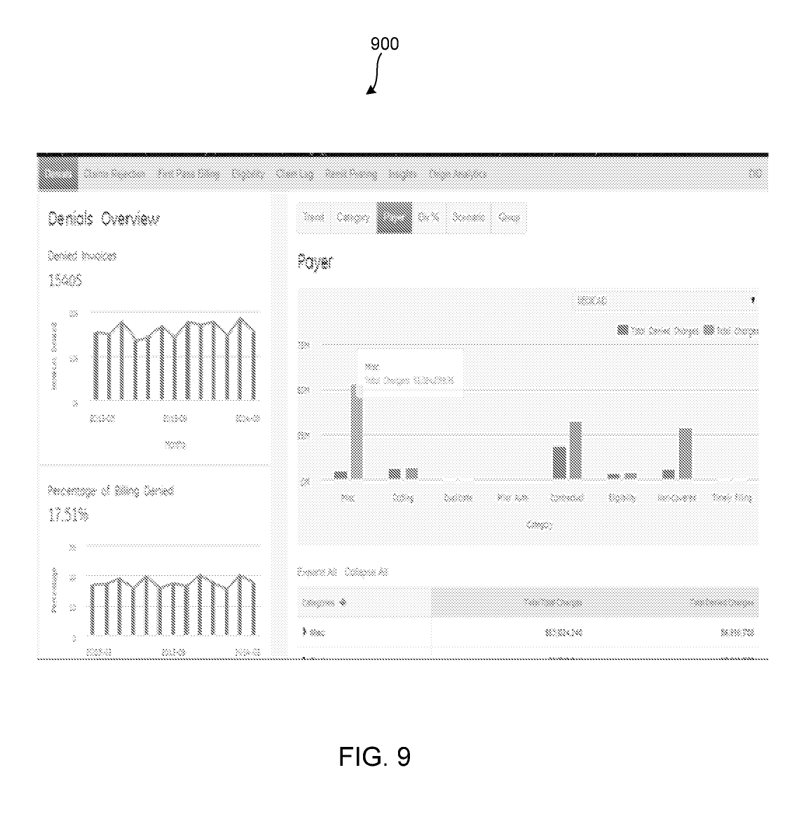

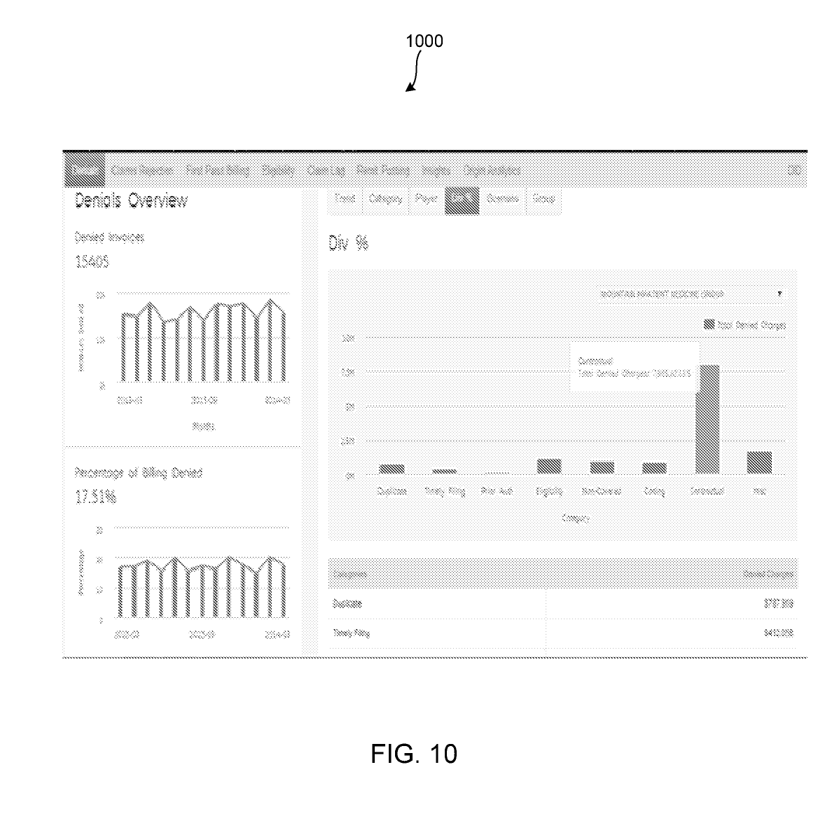

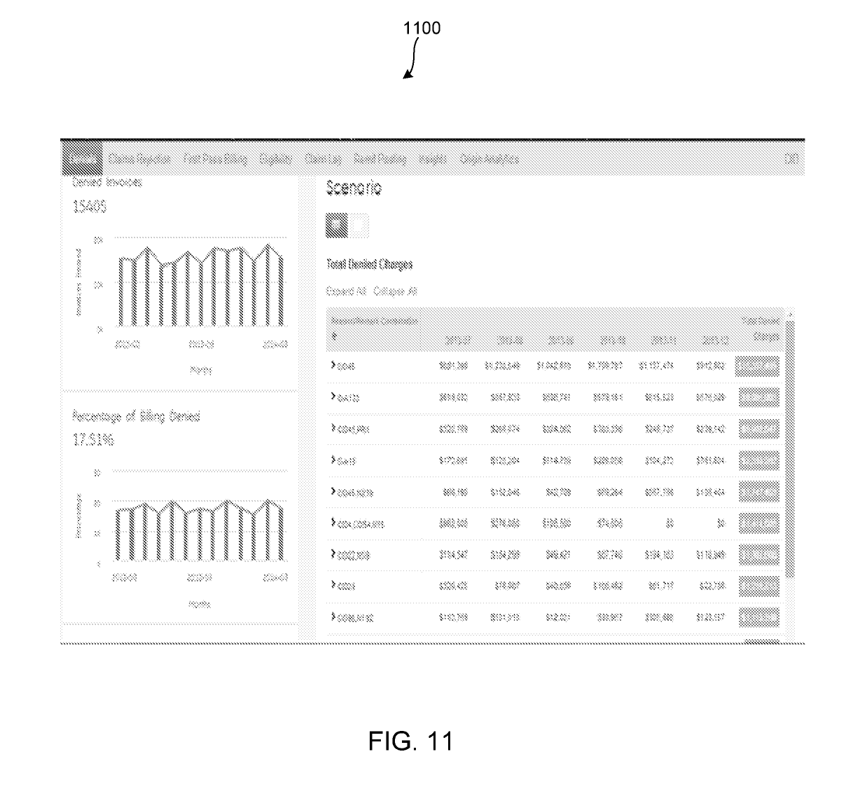

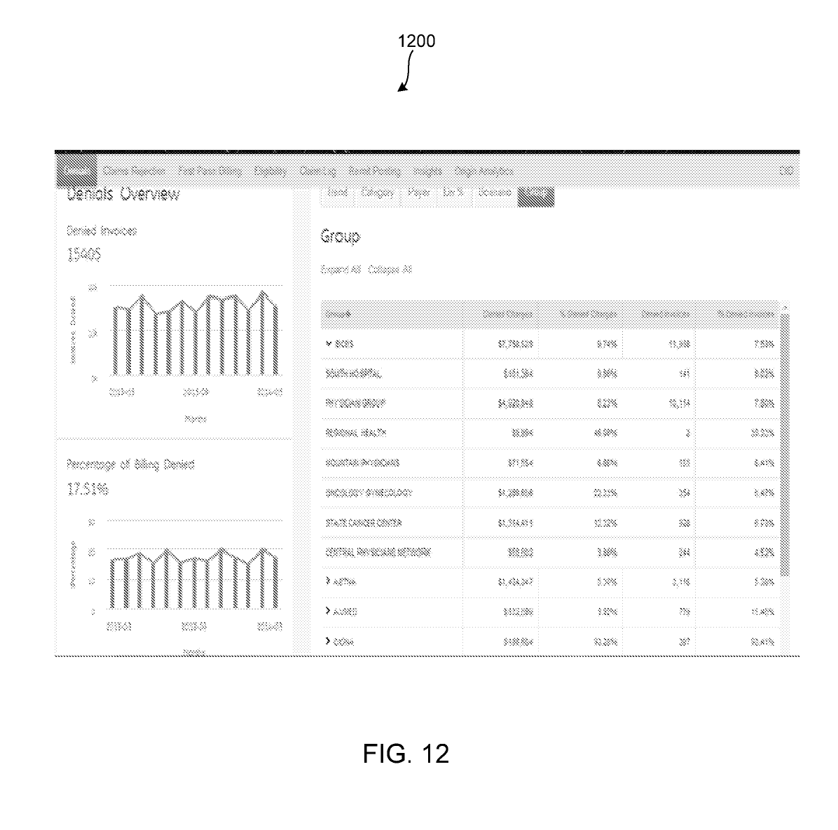

As illustrated by the example interface views 900, 1000, 1100 of FIGS. 9-11, information can be viewed by payer (e.g., FIG. 9), percentage (e.g., FIG. 10), scenario (e.g., FIG. 11), group (e.g., FIG. 12), and the like.

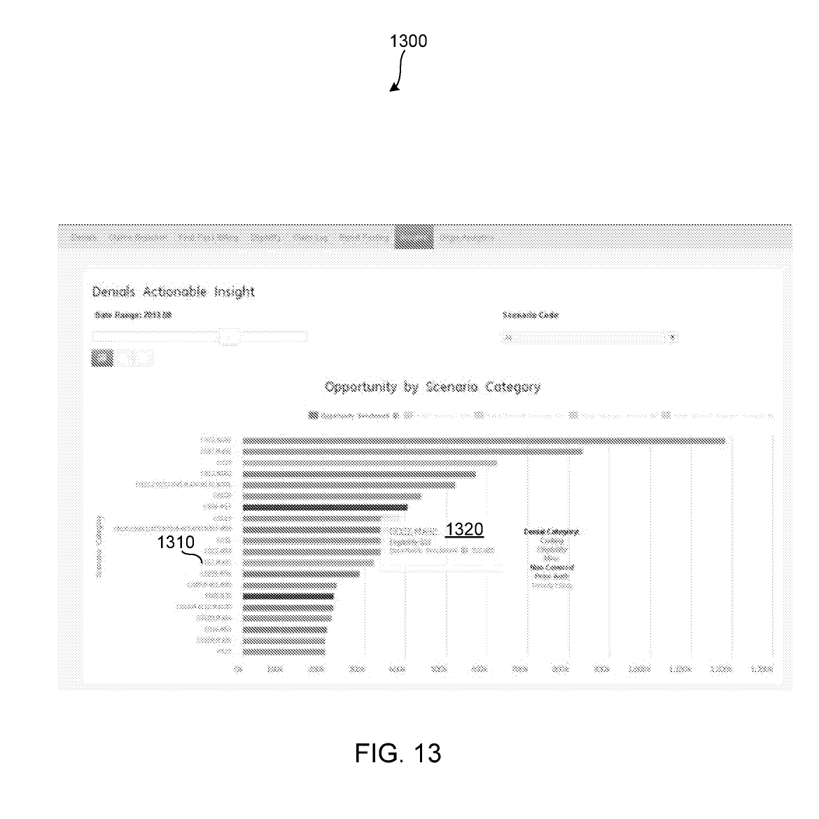

FIG. 13 shows an example interface 1300 providing actionable insight for a user with respect to a condition, such as invoice denials. As shown in the example, the interface 1300 provides a representation of actionable opportunity by category (e.g., by denial category or type descriptor including coding, eligibility, miscellaneous, non-covered, prior authorization, family filing, etc.) illustrating an acute area of need related to a particular denial (e.g., a CO22, or “care may be covered by another payer per coordination of benefits”). Included with the example view 1300 of FIG. 13 is a visualization of an “opportunity benchmark” represented by both an estimated cost of rework and an impact to working capital to an associated organization. As depicted in the example of FIG. 13, by selecting and/or otherwise positioning a cursor over a denial scenario category 1310 (e.g., a denial scenario code CO22,MA92 related to eligibility), additional information regarding those denials is provided (e.g., an opportunity benchmark of $322,405).

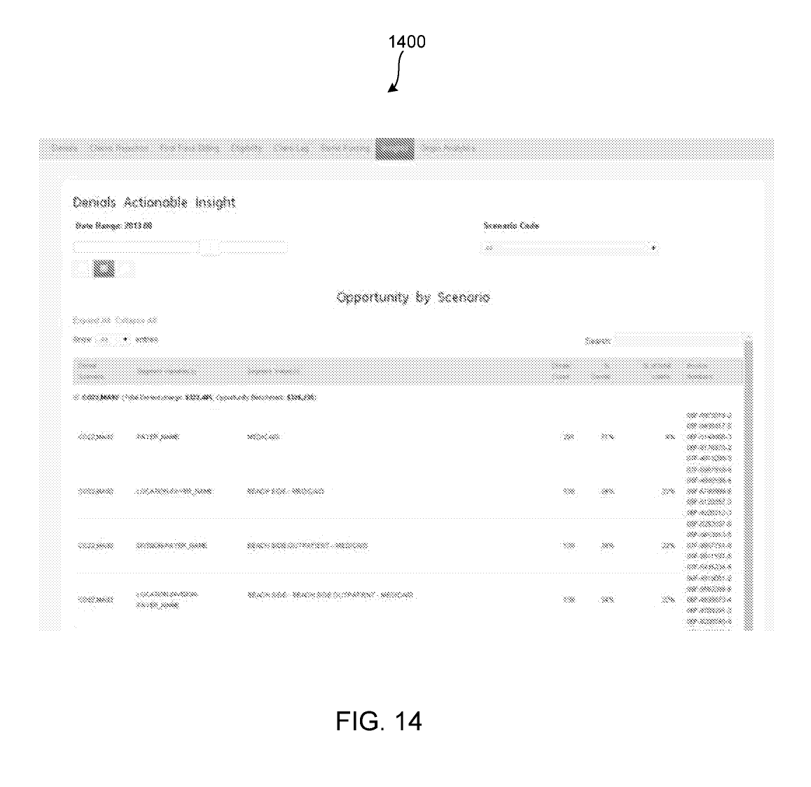

As illustrated in the example of FIG. 14, by clicking on denial scenarios, a user can quickly drill into specifics of a denial scenario to better assess a source of the issue as it pertains to a payer breakdown. In the example of FIG. 14, a denial issue is identified as being most prevalent with a single payer. A focused analysis can then be conducted on the issue data for the single payer.

The example of FIG. 14 shows a list of recent encounters ranked by dollar value displayed via a denials scenario interface 1400. Upon review, the data in the list shows an issue with balance billing to Medicaid which can be corrected with an adjustment to claim logic to include correct carrier codes, a problem being seen for the first time with this payer per the denials data in this example. A ranking can be constructed based on how the data is from an expected and/or predicted value. Then, in an N-way analysis, (e.g., a 2-way analysis with payer and division), which payers had which percentage of the denials can be determine. If commonality is found in the variables, the information becomes actionable. Denial can be reviewed retrospectively and/or predictively to fix a problem and/or recommend how to avoid a problem, for example.

For example, as shown in FIG. 14, in the month of 2013 August, there were 411 claims with denial scenario code C022,MA92. Of these claims, 291 (71%) have a payer name of MEDICAID. In the example of FIG. 14, by eliminating this issue, an organizational savings of roughly $322,000 in the given month due to cost of rework eliminated as well as overall improvement in working capital. While the savings is an incremental change, an immediate benefit is provided to the organization as well as an ability to free up resources to focus on other mission critical tasks.

Thus, certain examples provide analytics to unlock potential by providing advanced capabilities to survey performance across systems to pinpoint operational gaps, potential root causes, and to merge data and technology to create “self-healing” systems. Certain aspects provide access to clinical and financial data, an ability to assess for financial leakages in a target system, and technology solutions that are adaptable to target workflow(s).

Thus, certain aspects compute expected values and apply one or more statistical algorithm(s), data mining and/or machine learning algorithm(s), and/or database method(s), to identify patterns in the data. Unexpected association(s) and causal variable(s) leading to the association(s) can be identified. A semantic model of expected behavior is built for each causal/conditional variable. The semantic model of a particular person, business process, computer system, etc., is applied to the variables and association to identify next step(s) for corrective action.

Factors and associated observations can be gathered based on identified pattern(s) and rule(s). In certain examples, for the methods listed above, for each identified rule or pattern, one or more parent rules having more variables/factors and covering all or most of the same observations can be identified to determine the most broadly applicable rule(s) for the pattern(s). Once rule(s) and/or pattern(s) have been created, the rules can be grouped into rule set(s) in which a rule set includes one or more rules having the same variable(s)/factor(s).

In contrast to conventional wisdom, identification of an anomaly in certain aspects implies a relation to a root cause or an expression of a root cause. Certain aspects extrapolate that a pattern is occurring in the data because of this root cause(s). Because this pattern is unexpected, the system assumes that there is a root cause and drives down into the pattern. While such analysis may take a lifetime by hand, identification, investigation, and action can occur in minutes using a computer and/or other processor to provide real-time and/or substantially real-time notice (e.g., given some processing, transmission, and/or storage delay).

Certain aspects make a data processing output operable for a user and/or other system. A notification service (e.g., running nightly, weekly, etc.) can flag items that have changed and items that can be acted on. Flagged items can be generated automatically and sent out to subscribing and/or other relevant users. Flagged items and/or other notifications can be filtered to provide the most important things to a user (e.g., based on that user's filter configuration) and/or system.

Certain aspects utilize one or more statistical, data mining, machine learning, and/or database analytical methods to identify patterns and semantic models of people, business processes, and computer systems to assist in identification of root causes and recommendations associated with claim denials. Certain aspects automatically assign denials to an appropriate task management and workflow system, create transaction edits, and the like.

An example task management system (e.g., GE Centricity® Business Enterprise Task Management (ETM)) combines technology with business process and people to improve and sustain value. The example task management system is a rules-based workflow tool to improve revenue cycle performance and productivity. The example task management system can be used to create, track, and work claim edits, insurance follow-up tasks, registration and appointment follow-up tasks, etc. The example task management system provides updates to accounts receivable, for example.

An example transaction editing system (e.g., GE Centricity® Business Transaction Editing System (TES)) is a front-end transaction suspense system designed to capture, evaluate, correct, and extract charge and claim transactions to billing and accounts receivable. Incomplete and/or incorrect information in insurance claims can be identified and remedied before a claim is sent to the payer. The example transaction editing system identifies errors and allows a user to edit encounters and transactions, edit registration information, change status, inquire as to status, etc.

In certain examples, an identified denial can drive a change in the TES and/or ETM. Certain aspects identify clients in a client base which have the most opportunity to improve and/or which have the highest value in improving. Clients can be scored in a two-dimensional matrix, for example, and benchmarking can be done among peers to see how a particular client is doing.

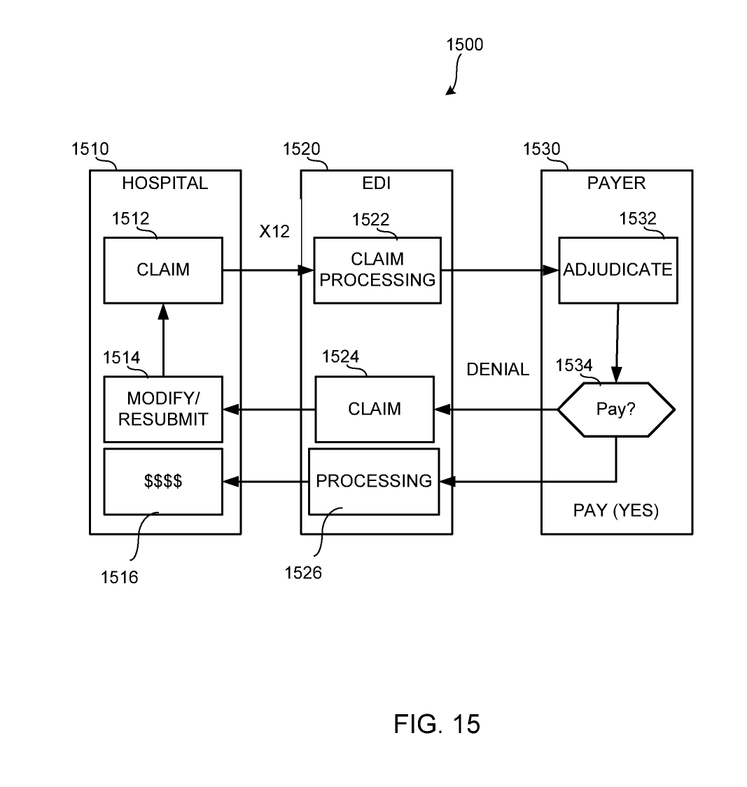

FIG. 15 illustrates an example knowledge-driven analytics system 1500 interconnecting a provider 1510, EDI 1520, and a payer 1530. Using knowledge-driven claim denial analytics, the hospital 1510 submits a claim 1512 to the EDI 1520 for processing 1522. The EDI 1520 sends the processed claim to the payer 1530 for adjudication of the claim 1532. The adjudication 1532 determines whether or not the claim is to be paid 1534. If the claim is to be paid, then the payment is provided to the EDI 1520 for processing 1526, and payment 1516 is sent to the hospital 1510. If payment is denied by the payer 1530, then the claim denial 1524 is provided to the EDI 1520, which provides instructions to modify and/or resubmit 1514 to the hospital 1510.

As discussed above, using technology to provide analytics, visualization, and semantics, denials can be reduced and/or resubmissions can be streamlined and improved, for example. Using knowledge-driven analytics, denial cost and return on investment can be characterized, pattern(s) can automatically be discovered in denials, and root cause(s) can be identified. A user can be notified when a difference can be made, and the system can 1) recommend action to be taken to fix a current situation and/or 2) recommend change to avoid future problem. Additionally, emerging trend(s) can be identified, and the system can facilitate response to those trend(s).

### IV. EXAMPLE METHODS

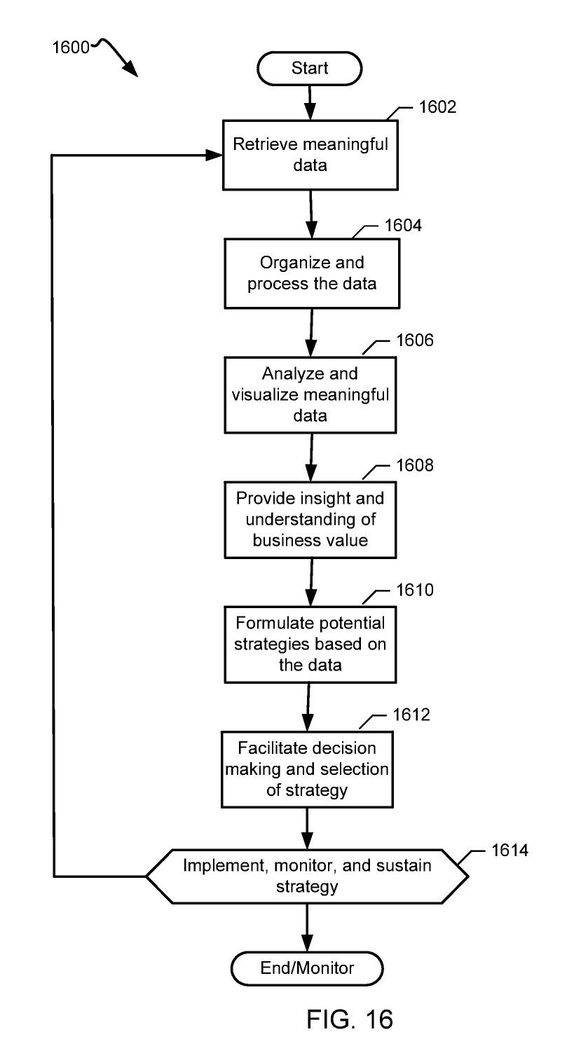

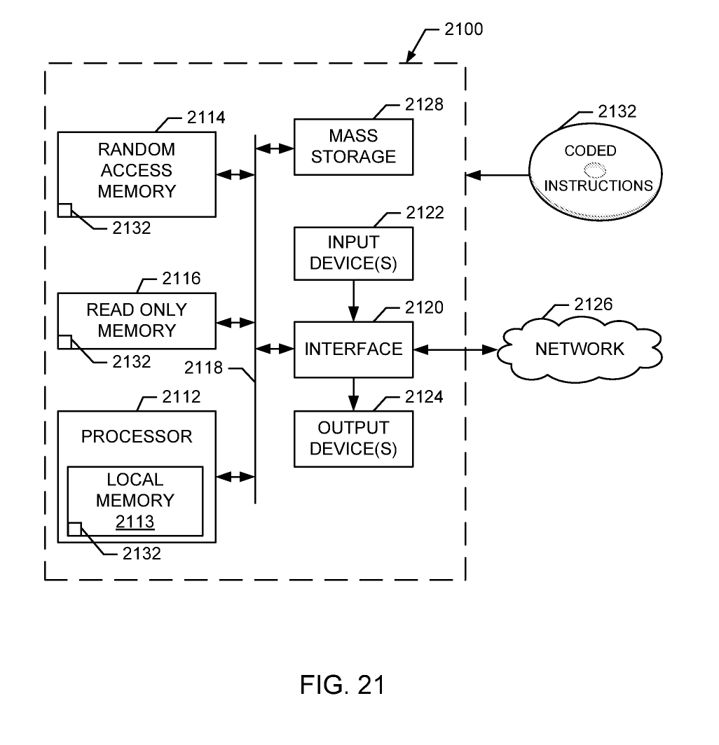

Flowcharts representative of example machine readable instructions for implementing the example systems of FIGS. 1-15 are shown in FIGS. 16-19. In these examples, the machine readable instructions comprise a program for execution by a processor such as processor 2112 shown in the example processor platform 2100 discussed below in connection with FIG. 21. The program can be embodied in software stored on a tangible computer readable storage medium such as a CD-ROM, a floppy disk, a hard drive, a digital versatile disk (DVD), a BLU-RAY™ disk, or a memory associated with processor 2112, but the entire program and/or parts thereof could alternatively be executed by a device other than processor 2112 and/or embodied in firmware or dedicated hardware. Further, although the example program is described with reference to the flowcharts illustrated in FIGS. 16-19, many other methods of implementing the example systems and methods can alternatively be used. For example, the order of execution of the blocks can be changed, and/or some of the blocks described can be changed, eliminated, or combined.

As mentioned above, the example processes of FIGS. 16-19 can be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 16-19 can be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

As shown in the example, of FIG. 16, at block 1602, in an example analytics capability model, meaningful data is retrieved or collected. For example, meaningful data includes healthcare EDI payment transactions (e.g., X12 documents, ANSI 837 claims, ANSI 835 remits, ANSI 277CA rejections, etc.), server logfiles, equipment fault data, machine alarm data, machine to machine status data, etc.

At block 1604, the data is organized and processed. For example, the data can be put into a relational database, online analytical processing (OLAP) cube, other data array, etc., for analytical and/or other data processing. The data can be processed, for example, using one or more methods including (a) one or more statistical algorithms such as linear regression, logistic regression, non-linear regression, principle components, etc.; (b) one or more data mining and/or machine learning algorithms such as support vector machines, artificial neural networks, hierarchical clustering, linear discriminant analysis, contrast set mining, separating hyperplanes, decision trees, Bayesian analysis, linear classifiers, association rules, self-organizing maps, random forests, etc.; and/or (c) one or more database structured query language (SQL) methods such as aggregation, OLAP cubes, etc.

Factors and associated observations can be gathered based on identified pattern(s) and rule(s). In certain examples, for the methods listed above, for each identified rule or pattern, one or more parent rules having more factors and covering all or most of the same observations can be identified to determine the most broadly applicable rule(s) for the pattern(s). Once rule(s) and/or pattern(s) have been created, the rules can be grouped into rule set(s) in which a rule set includes one or more rules having the same factor(s).

At block 1606, analysis and visualization of meaningful data is realized. For example, one or more visual charts, graphs, tables, etc., can be generated based on the analytical and/or other data processing.

At block 1608, insight into and understanding of a business value of the data are determined. For example, questions can be answered such as pattern identification, pattern occurrence/timing, quantification of financial cost, etc.

At block 1610, potential strategies are formulated based on the data. For example, one or more approaches to solve an identified problem (e.g., associated with an identified pattern of data) is selected. For example, automated rules can be implemented to alert for and correct future problems, new automated workflows can be generated, procedures and/or training can be updated, etc. At block 1612, strategy selection and decision making are provided. For example, one of the one or more approaches to solve the identified problem can be selected.

At block 1614, change can be implemented, monitored, and sustained for long-term improvement. For example, output for change can be automatically forwarded to drive a subsequent workflow (e.g., an automated ETM workflow, etc.), can be fed into a tool (e.g., TES, etc.) to automatically transform the claim before the claim is tested and/or sent to a subsequent workflow, etc. Output can be added to a list of items to be monitored (e.g., a dashboard, task list, command center, key performance indicator (KPI), etc., that can be tracked), and an immediate and/or future notification or alert can be triggered based on a value of the output compared to a limit/threshold (e.g., an upper and/or lower limit, etc.). For example, the output can be transformed into a KPI and provided to a statistical process control (SPC) process control system for further monitoring and alert.

Thus, technology can be developed, implemented, and sustained to create customer value. Analytics are leveraged to provide valuable insights into specialized workflows, helping optimize or improve information technology (IT) systems and accelerate revenue including workflow operations (e.g., improved revenue cycle flow and operations, etc.), eligibility workflow optimization (e.g., custom-tailored tools and eligibility performance improvement, etc.), point of service optimization (e.g., improved identification of copay and other patient liability amounts, tracking collections, identifying variances, etc.), and performance management (e.g., leveraging analytics and onsite workouts to help identify data trends and anomalies contributing to performance issues, etc.).

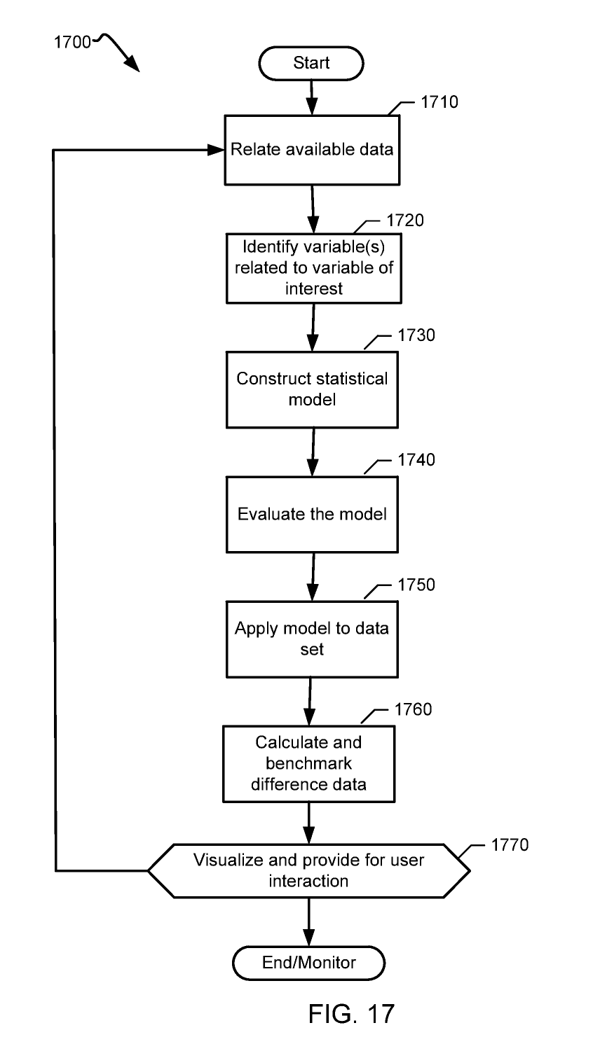

FIG. 17 illustrates an example method 1700 to process data for identification, visualization, and interaction. At block 1710, data in a data set is related. For example, relationship(s) between different variables in the data set is described. Data can include healthcare EDI payment transactions (e.g., X12 documents, ANSI 837 claims, ANSI 835 remits, ANSI 277CA rejections, etc.), server logfiles, equipment fault data, machine alarm data, machine to machine status data, etc.

At block 1720, variables related to a variable of interest (e.g., claim denials) are identified. Variables of interest for Healthcare EDI payment transactions include denial reason codes, denial group codes, denial remark codes, fiscal week, month, year, division, payer, insurance plan, provider organization data (e.g., location, hospital name, group name, billing area, etc.), procedure codes (e.g., CPT Codes, HCPC Codes, etc.) and associated multi-level hierarchy of procedure codes, diagnosis codes (e.g., ICD9, ICD10, etc.) and associated multi-level hierarchy of diagnosis codes, etc.

At block 1730, a statistical model is constructed based on the variables in the data set (including the variable of interest). For example, one or more statistical and/or data mining methods can be used to construct a statistical model based on the variables in the data set. At block 1740, the model is evaluated (e.g., a prediction is made). For example, the model can be evaluated by calculating expected value and associated model validation statistics including confidence intervals, P values, odds ratios, chi-squared, etc.

At block 1750, the model is applied to the data set (e.g., the prediction is reshaped to be useful). For example, the model built at blocks 1730-1740 is evaluated for each observation. At block 1760, information, such as error, ratio, delta, etc., between the prediction/model and observed data is calculated and benchmarked. For example, aggregated statistics can be calculated for model performance.

At block 1770, results are visualized and presented to a user for review, selection, and action. For example, factors used in the model can be visualized along with a count of observations, ratio(s) and/or percentage(s) of the count of observations as a fraction of a population, aggregate statistics such as a sum of metrics (e.g., cost, benefit, etc.), and/or benchmark data calculated at block 1760 can be visualized. The visualization can facilitate interaction for exploration such as allowing a drill down to atomic-level observation data, as well as enabling further action such as copy, email and/or other routing to automated and/or manual workflows such as ETM and/or to rule execution systems such as TES, etc.

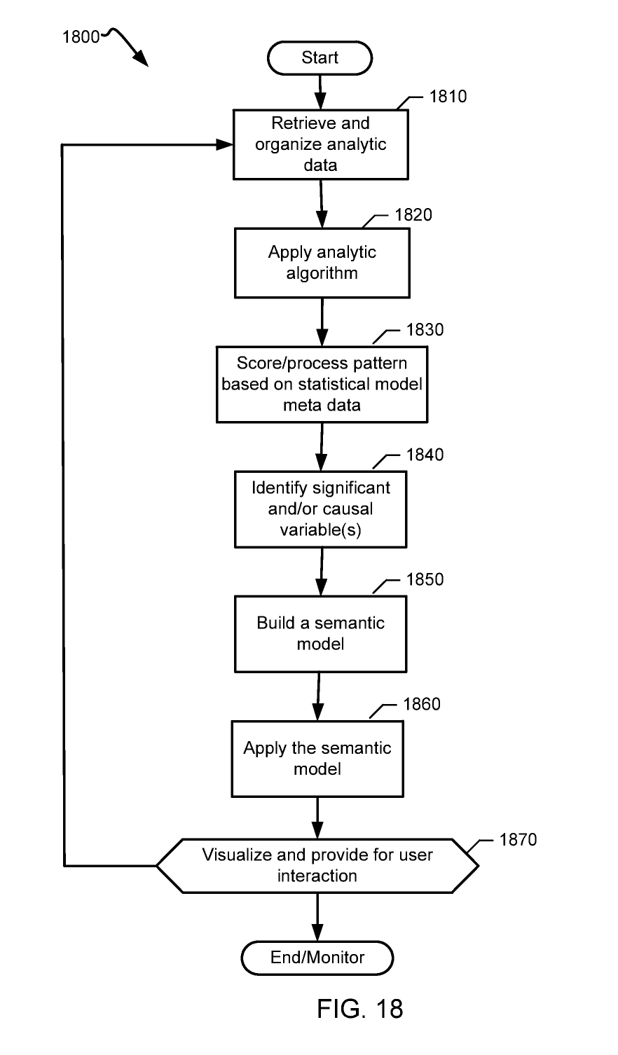

For example, in more or different detail, FIG. 18 illustrates an example method 1800 to process data into information and to make the information actionable. At block 1810, analytic data is retrieved and organized. For example, data can include Healthcare EDI payment transactions (e.g., X12 documents, ANSI 837 Claims, ANSI 835 Remits, ANSI 277CA Rejections, etc.), server logfiles, equipment fault data, machine alarm data, machine to machine status data with variables (e.g., variables that in Healthcare EDI payment transactions include denial reason codes, denial group codes, denial remark codes, fiscal week, month, year, division, payer, insurance plan, provider organization data: such as location, hospital name, group name, billing area, etc.), procedure codes (e.g., CPT Codes, HCPC Codes, etc.) and associated multi-level hierarchy of procedure codes, diagnosis codes (e.g., ICD9, ICD10, etc.) and associated multi-level hierarchy of diagnosis codes, etc.

At block 1820, an analytic algorithm is applied. For example, one or more analytic methods are applied to the data to identify patterns in the data. For example, statistical algorithms such as linear regression, logistic regression, non-linear regression, principle components, etc., can be applied. Alternatively or in addition, data mining and machine learning algorithms such as support vector machines, artificial neural networks, hierarchical clustering, linear discriminant analysis, contrast set mining, separating hyperplanes, decision trees, Bayesian analysis, linear classifiers, association rules, self-organizing maps, random forests, etc., can be applied. As a further alternative or addition, database SQL methods such as aggregation, OLAP cubes, etc., can be applied to identify pattern(s).

At block 1830, pattern(s) are scored and processed based on a comparison with statistical model meta data. For example, pattern(s)/trend(s) are scored with respect to statistical model meta data such as a p value, odds ratio, relative risk, business metric (e.g., revenue, cost, etc.), etc. Pattern(s)/trend(s) having an unexpected characteristic or association based on the score, such as a p value that is below a specified threshold, a high odds ratio above a specified threshold, support above a specified threshold, a combination of these, etc., are processed. An unexpected association can be identified based on the patterns and scores, for example.

At block 1840, one or more significant and/or causal variables leading to the association are identified. For example, for each pattern identified and processed at block 1830, factors used in the pattern are identified and extracted.

At block 1850, a semantic model is built for each causal/significant variable. For example, a semantic model can be built for a business system and/or expected behavior which includes a model of people, processes, and business processes. For claims denials, for example, a semantic model can also be built to include denial reason and remark codes and resolution strategy(-ies) for different constituent cases. The semantic model can provide codes and description for denials, etc. For example, based on an identification of unusual denial patterns, reasoning can be used to infer denial root causes through the semantic model.

At block 1860, the semantic model is applied to the identified causal variable(s) and association to identify next action(s) to correct an anomaly, defect, and/or deficiency. For example, a semantic reasoning engine can be used to infer or reason over the semantic model for the invoices or patterns to understand root causes, next actions, and resolution strategies. The semantic reasoning/inference engine can determine a root cause (e.g., by deriving a root cause from reason and remark codes modeled in the semantic model, etc.) and reconcile a root cause with an invoice, etc., to determine next action(s) and/or resolution strategy(-ies) associated with the root cause, for example. Relationships between data are not explicitly mentioned in the data, but by modeling the data in a semantic model with shared, standardized, unambiguous definitions of terms and relationships as well as modeled denial reason and remark code definitions, knowledge can be applied to the data to infer those relationships (e.g., infer root causes for denials, predict potential reason/remark codes for a claim, provide a knowledge graph, etc.). In some examples, a payer/provider system description, action description, and the semantic model description combine to provide a problem description and resolution through recommended next action(s).

At block 1870, visualization is provided and interaction is enabled to facilitate next action(s). For example, visualization(s), alert(s), and/or natural language output can be created to describe a problem, a root cause, next action(s), and associated system(s)/workflow(s) that can be initiated. Thus, for a given invoice, reasoning to a root cause and action provides invoice information such as a denial reason code and description, meta reasoning associated with the denial, root cause(s), and a problem description and recommendation for next action(s) in natural language. Such items can be selected for automated/system-based next action as well, for example.

For example, next action(s)/step(s) (e.g., a recommended action) to resolve the problem (e.g., denials) can be recommended based on the root cause(s) identified through the semantic model. The semantic model and reasoning engine can further predict an expected recovery for each recommendation. Natural language output can be generated with a problem description, root cause, resolution(s), etc., and can be integrated with one or more external systems to affect resolution (e.g., ETM, workflow engine(s), etc.). A recommended action can be automatically triggered via an output of the semantic model and reasoning engine, for example. Through TES and/or other system/workflow, future denials can be reduced/prevented through automatic change and/or hold of claims, for example.

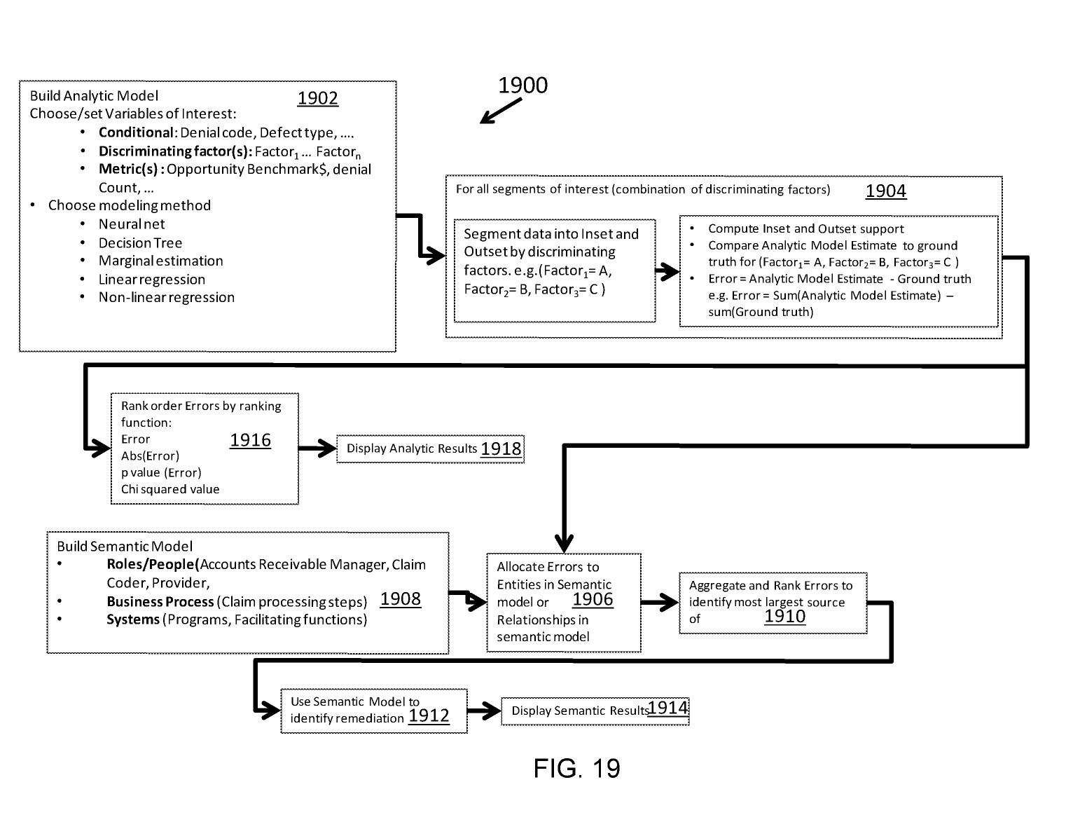

FIG. 19 illustrates an example method 1900 providing additional example detail regarding building of an analytic/semantic model to discover patterns, identify root causes, and notify a user of meaningful differences. At block 1902, an analytic model is built. The model can be built by selecting one or more variables of interest, such as conditional variable(s) (e.g., denial code, defect type, etc.), discriminating factor(s) (e.g., factor 1 . . . factor n), metric(s) (e.g., opportunity benchmark, denial count, etc.), etc. A modeling method is also selected, such as a neural net, decision tree, marginal estimation, linear regression, non-linear regression, etc. The model can be built using one or more data mining/analytic algorithms/methods disclosed above (e.g., statistical algorithms (such as linear regression, logistic regression, non-linear regression, principle components, etc.), data mining and machine learning algorithms (such as support vector machines, artificial neural networks, hierarchical clustering, linear discriminant analysis, contrast set mining, separating hyperplanes, decision trees, Bayesian analysis, linear classifiers, association rules, self-organizing maps, random forests, etc.), database SQL methods such as aggregation, OLAP cubes, etc.), etc.) applied to business metrics such as revenue, cost, profit, denial count, etc.

At block 1904, a combination of discriminating factors is determined for one or more segments of interest. For example, data is segmented into an inset and outset based on discriminating factor (e.g., Factor1=A, Factor2=B, Factor3=C). Support for both inset and outset are computed, and the estimate of the analytic model is compared to ground truth for each factor (e.g., Factor1=A, Factor2=B, Factor3=C). An error is then computed by removing the ground truth from the analytic model estimate (e.g., Error=sum(Analytic Model Estimate)−sum(Ground Truth)). Error can be evaluated based on a comparison between a computed expected value and a measured value. A result that is different than expected can be flagged, and causal variables leading to the association can be identified (and addressed).

At block 1908, a semantic model is built. The semantic model is based on one or more roles/people (e.g., accounts receivable manager, claim coder, provider, etc.), business process (e.g., claim processing steps, etc.), system (e.g., programs, facilitating functions, etc.), and the like. For example, a semantic model can be built for each causal/significant variable. For example, a semantic model can be built for a business system and/or expected behavior which includes a model of people, processes, and business processes. For claims denials, for example, a semantic model can also be built to include denial reason and remark codes and resolution strategy(-ies) for different constituent cases. The semantic model can be applied to the identified causal variable(s) and association to identify next action(s) to correct an anomaly, defect, and/or deficiency.

At block 1906, errors determined at block 1904 are allocated to entities in the semantic model and/or relationships in the semantic model. For example, a semantic reasoning engine can be used to infer or reason over the semantic model for the invoices or patterns to understand root causes, next steps, and resolution strategies. Errors, costs, revenue, and/or other business metrics can be allocated to the output of the semantic model. At block 1910, errors are aggregated and ranked to identify a largest source of error, costs, revenue, and/or other business metric(s).

At block 1916, errors are ranked in an order by ranking function. For example, errors can be ranked based on error, abs(error), p value(error), chi squared value, etc.

At block 1912, the semantic model is used to identify a remediation or other recommended action for the largest source of error. Using the semantic descriptions of the actions that can be taken for a root cause, for example, a reasoning engine can be used to infer action(s) that can be taken to remediate the problem/largest source of error. At block 1914, the semantic results are displayed for user review and action. For example, visualization(s), alert(s), and/or natural language output can be created to describe a problem, a root cause, next action(s), and associated system(s)/workflow(s) that can be initiated.

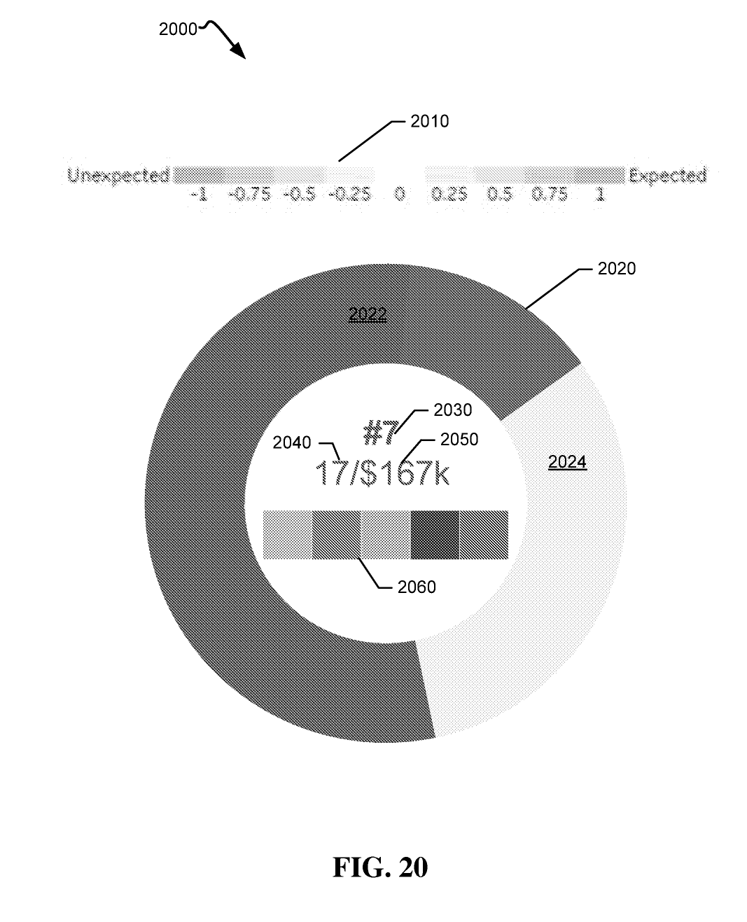

FIG. 20 illustrates an example visualization 2000 of a trend extracted from pattern(s) in data based on user value. As indicated by the gradient 2010, a level of expectedness can be provided based on past history (e.g., from unexpected to expected, etc.). Color, shading, texture, and/or other visual pattern can be used to indicate a position along the expectedness gradient 2010 for the determined trend. Additionally, as shown in the example of FIG. 20, a ring or donut 2020 represents a pattern set or a collection of patterns with the same factors. The example pattern set 2020 includes one or more segments 2022, 2024 which each indicate a particular pattern within the pattern set. Further, a particular pattern 2030 can be identified (e.g., pattern #7) and further information 2040, 2050 can be displayed for that pattern 2030, such as a number of denials 2040 within the pattern 2030 (e.g., 17), a total amount in denied charges 2050 for the pattern 2030 (e.g., $167,000), etc. A number of factors 2060 contributing to the pattern 2030 can also be graphically represented. The example visualization 2000 can be a dynamic interface, allowing a user to zoom, filter, select, and/or drill down into the base data that forms the particular pattern 2030, for example.

### V. COMPUTING DEVICE

The subject matter of this description may be implemented as stand-alone system or for execution as an application capable of execution by one or more computing devices. The application (e.g., webpage, downloadable applet or other mobile executable) can generate the various displays or graphic/visual representations described herein as graphic user interfaces (GUIs) or other visual illustrations, which may be generated as webpages or the like, in a manner to facilitate interfacing (receiving input/instructions, generating graphic illustrations) with users via the computing device(s).

Memory and processor as referred to herein can be stand-alone or integrally constructed as part of various programmable devices, including for example a desktop computer or laptop computer hard-drive, field-programmable gate arrays (FPGAs), application-specific integrated circuits (ASICs), application-specific standard products (ASSPs), system-on-a-chip systems (SOCs), programmable logic devices (PLDs), etc. or the like or as part of a Computing Device, and any combination thereof operable to execute the instructions associated with implementing the method of the subject matter described herein.

Computing device as referenced herein may include: a mobile telephone; a computer such as a desktop or laptop type; a Personal Digital Assistant (PDA) or mobile phone; a notebook, tablet or other mobile computing device; or the like and any combination thereof.

Computer readable storage medium or computer program product as referenced herein is tangible (and alternatively as non-transitory, defined above) and may include volatile and non-volatile, removable and non-removable media for storage of electronic-formatted information such as computer readable program instructions or modules of instructions, data, etc. that may be stand-alone or as part of a computing device. Examples of computer readable storage medium or computer program products may include, but are not limited to, RAM, ROM, EEPROM, Flash memory, CD-ROM, DVD-ROM or other optical storage, magnetic cassettes, magnetic tape, magnetic disk storage or other magnetic storage devices, or any other medium which can be used to store the desired electronic format of information and which can be accessed by the processor or at least a portion of the computing device.

The terms module and component as referenced herein generally represent program code or instructions that causes specified tasks when executed on a processor. The program code can be stored in one or more computer readable mediums.

Network as referenced herein may include, but is not limited to, a wide area network (WAN); a local area network (LAN); the Internet; wired or wireless (e.g., optical, Bluetooth, radio frequency (RF)) network; a cloud-based computing infrastructure of computers, routers, servers, gateways, etc.; or any combination thereof associated therewith that allows the system or portion thereof to communicate with one or more computing devices.

The term user and/or the plural form of this term is used to generally refer to those persons capable of accessing, using, or benefiting from the present disclosure.

FIG. 21 is a block diagram of an example processor platform 2100 capable of executing the instructions of FIGS. 16-19 to implement the example systems of FIGS. 1-15. The processor platform 2100 can be, for example, a server, a personal computer, a mobile device (e.g., a cell phone, a smart phone, a tablet such as an IPAD™), a personal digital assistant (PDA), an Internet appliance, or any other type of computing device.

The processor platform 2100 of the illustrated example includes a processor 2112. Processor 2112 of the illustrated example is hardware. For example, processor 2112 can be implemented by one or more integrated circuits, logic circuits, microprocessors or controllers from any desired family or manufacturer.

Processor 2112 of the illustrated example includes a local memory 2113 (e.g., a cache). Processor 2112 of the illustrated example is in communication with a main memory including a volatile memory 2114 and a non-volatile memory 2116 via a bus 2118. Volatile memory 2114 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2116 can be implemented by flash memory and/or any other desired type of memory device. Access to main memory 2114, 2116 is controlled by a memory controller.

Processor platform 2100 of the illustrated example also includes an interface circuit 2120. Interface circuit 2120 can be implemented by any type of interface standard, such as an Ethernet interface, a universal serial bus (USB), and/or a PCI express interface.

In the illustrated example, one or more input devices 2122 are connected to the interface circuit 2120. Input device(s) 2122 permit(s) a user to enter data and commands into processor 2112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 2124 are also connected to interface circuit 2120 of the illustrated example. Output devices 2124 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). Interface circuit 2120 of the illustrated example, thus, typically includes a graphics driver card, a graphics driver chip or a graphics driver processor.

Interface circuit 2120 of the illustrated example also includes a communication device such as a transmitter, a receiver, a transceiver, a modem and/or network interface card to facilitate exchange of data with external machines (e.g., computing devices of any kind) via a network 2126 (e.g., an Ethernet connection, a digital subscriber line (DSL), a telephone line, coaxial cable, a cellular telephone system, etc.).

Processor platform 2100 of the illustrated example also includes one or more mass storage devices 2128 for storing software and/or data. Examples of such mass storage devices 2128 include floppy disk drives, hard drive disks, compact disk drives, Blu-ray disk drives, RAID systems, and digital versatile disk (DVD) drives.

Coded instructions 2132 associated with any of FIGS. 1-20 can be stored in mass storage device 2128, in volatile memory 2114, in the non-volatile memory 2116, and/or on a removable tangible computer readable storage medium such as a CD or DVD.

It may be noted that operations performed by the processor platform 2100 (e.g., operations corresponding to process flows or methods discussed herein, or aspects thereof) may be sufficiently complex that the operations may not be performed by a human being within a reasonable time period.

### VI. CONCLUSION

Thus, certain examples provide a clinical knowledge platform that enables healthcare institutions to improve performance, reduce cost, touch more people, and deliver better quality globally. In certain examples, the clinical knowledge platform enables healthcare delivery organizations to improve performance against their quality targets, resulting in better patient care at a low, appropriate cost.

Certain examples facilitate improved control over data. Certain examples facilitate improved control over process. Certain examples facilitate improved control over outcomes. Certain examples leverage information technology infrastructure to standardize and centralize data across an organization. In certain examples, this includes accessing multiple systems from a single location, while allowing greater data consistency across the systems and users.

Certain examples surface a specific area of interest that might not previously have been a focus and help a user identify specific groups of denials on which to focus effort and workflows without leaving value on the table. Certain examples make it possible to identify specific groups of denials that are worth following up on: generating a workflow, digging into what went wrong, etc., for identified buckets.

Certain examples translate data into workflow priority, create work standards and define tasks for team members. Certain examples provide a target for management to drill into by Division, Practice, CPT Code, Eligibility Code, etc. Certain examples track effectiveness of change over time and facilitate tracks of current state versus future state. Certain examples identify and alert for emerging patterns.

Technical effects of the subject matter described above may include, but is not limited to, providing systems and methods to generate actionable information through knowledge-driven analytics to improve responsiveness and correction of errors (e.g., as shown in the example systems/interfaces of FIGS. 1-15 and 20 and methods of FIGS. 16-19).

Moreover, the system and method of this subject matter described herein can be configured to provide an ability to better understand large volumes of data generated by devices across diverse locations, in a manner that allows such data to be more easily exchanged, sorted, analyzed, acted upon, and learned from to achieve more strategic decision-making, more value from technology spend, improved quality and compliance in delivery of services, better customer or business outcomes, and optimization of operational efficiencies in productivity, maintenance and management of assets (e.g., devices and personnel) within complex workflow environments that may involve resource constraints across diverse locations.

As opposed to merely data mining for reporting or providing business intelligence, certain examples provide advanced analytics. The advanced analytics not only provide a data mining process that creates statistical models to predict future probabilities and trends but also utilize advanced algorithms and intuitive, interactive visualizations to easily digest and represent large, complex datasets and concepts. The presently disclosed advanced analytics provide insight into what will happen next and what should be done about it. The presently disclosed advanced analytics identify trends through identification and analysis of root cause factors, prioritize based on value, and help to identify and drive next actions to address those trends, for example. For example, patterns can be identified automatically and resolved as a unit (whereas manually reviewing and sorting 300 denials to identify one trend, and repeating for each pattern, would be impractical, if not impossible), and common themes can provide context without requiring further user research. The presently disclosed advanced analytics work with a digital solutions platform such as a service-oriented architecture framework to provide the advanced analytics in conjunction with data gathering, next action facilitation enablement, interoperability, and common user experience, for example. Dynamic visualizations display trends, organized based on value, and focus on particular trend(s) based on value, priority, preference, etc.

This written description uses examples to disclose the subject matter, and to enable one skilled in the art to make and use the invention. The patentable scope of the subject matter is defined by the following claims, and may include other examples that occur to those skilled in the art.

1. A system comprising:
a memory storing instructions for execution; and
a configured processor, the processor configured by executing the instructions stored in the memory to:
identify, using the processor, a pattern in a data set using an analytic algorithm, the data set associated with a domain;
process, using the processor, the identified pattern to assign a score to the identified pattern based on a comparison to statistical model meta data;
construct, using the processor, a semantic model modeling people, processes, and systems associated with the domain;
combine, using the processor, the identified pattern with the semantic model;
determine, using the semantic model and the processor, an output including: a) a root cause for the identified pattern and b) a recommended action to remediate the root cause; and
facilitate, using the processor, execution of the recommended action based on a trigger associated with the output.

2. The system of claim 1, wherein the statistical model meta data comprises at least one of a p value, an odds ratio, a relative risk, and a business metric.

3. The system of claim 1, wherein the identified pattern is associated with a denial of a claim.

4. The system of claim 1, wherein the trigger comprises at least one of an automated threshold comparison and rule matching.

5. The system of claim 1, wherein the processor is further configured to:
generate, using the processor, a visualization of the identified pattern using the identified pattern and the score.

6. The system of claim 1, wherein the processor is further configured to:
generate, using the processor, an alert associated with the identified pattern based on the identified pattern and the score.

7. The system of claim 6, wherein the alert, when analyzed singularly or combined with other alerts, is triggered when the identified pattern exceeds a significance threshold or matches a rule.

8. The system of claim 1, wherein the recommended action comprises creating a resolution system based on criteria associated with the identified pattern to automatically transform future pattern matches, wherein the transform includes a resolution to the root cause identified by the pattern and associated semantic model.

9. A non-transitory computer-readable storage medium including computer program instructions which, when executed by a processor, cause the processor to execute a method comprising:
identify, using the processor, a pattern in a data set using an analytic algorithm, the data set associated with a domain;
process, using the processor, the identified pattern to assign a score to the identified pattern based on a comparison to statistical model meta data;
construct, using the processor, a semantic model modeling people, processes, and systems associated with the domain;
combine, using the processor, the identified pattern with the semantic model;
determine, using the semantic model and the processor, an output including: a) a root cause for the identified pattern and b) a recommended action to remediate the root cause; and
facilitate, using the processor, execution of the recommended action based on a trigger associated with the output.

10. The computer-readable storage medium of claim 9, wherein the statistical model meta data comprises at least one of a p value, an odds ratio, a relative risk, and a business metric.

11. The computer-readable storage medium of claim 9, wherein the identified pattern is associated with a denial of a claim.

12. The computer-readable storage medium of claim 9, wherein the trigger comprises at least one of an automated threshold comparison and rule matching.

13. The computer-readable storage medium of claim 9, wherein the computer program instructions further configure the processor to:
generate, using the processor, a visualization of the identified pattern using the identified pattern and the score.

14. The computer-readable storage medium of claim 9, wherein the computer program instructions further configure the processor to:
generate, using the processor, an alert associated with the identified pattern based on the identified pattern and the score.

15. The computer-readable storage medium of claim 14, wherein the alert, when analyzed singularly or combined with other alerts, is triggered when the identified pattern exceeds a significance threshold or matches a rule.

16. The computer-readable storage medium of claim 9, wherein the recommended action comprises creating a resolution system based on criteria associated with the identified pattern to automatically transform future pattern matches, wherein the transform includes a resolution to the root cause identified by the pattern and associated semantic model.

17. A computer-implemented method comprising:
identifying, using a processor, a pattern in a data set using an analytic algorithm, the data set associated with a domain;
processing, using the processor, the identified pattern to assign a score to the identified pattern based on a comparison to statistical model meta data;
constructing, using the processor, a semantic model modeling people, processes, and systems associated with the domain;
combining, using the processor, the identified pattern with the semantic model;
determining, using the semantic model and the processor, an output including: a) a root cause for the identified pattern and b) a recommended action to remediate the root cause; and
facilitating, using the processor, execution of the recommended action based on a trigger associated with the output.

18. The method of claim 17, further comprising:
generate, using the processor, a visualization of the identified pattern using the identified pattern and the score.

19. The method of claim 17, further comprising:
generate, using the processor, an alert associated with the identified pattern based on the identified pattern and the score.

20. The method of claim 17, wherein the recommended action comprises creating a resolution system based on criteria associated with the identified pattern to automatically transform future pattern matches, wherein the transform includes a resolution to the root cause identified by the pattern and associated semantic model.
